(19) United States
(12) Patent Application Publication
(10) Pub. No.: US 2017/0208988 A1
(43) Pub. Date: Jul. 27, 2017

(54) HOT AND COLD WATER DELIVERY TO POD CONTAINING NUTRITIONAL COMPOSITION

(71) Applicant: ABBOTT LABORATORIES, Abbott Park, IL (US)

(72) Inventors: GARY KATZ, Columbus, OH (US); CATHERINE LAMB, Westerville, OH (US); TIMOTHY LAPLANTE, Powell, OH (US); JEREMY MCBROOM, Columbus, OH (US); SRIRAM THARMAPURAM, Dublin, OH (US)

(73) Assignee: ABBOTT LABORATORIES, Abbott Park, IL (US)

(21) Appl. No.: 15/328,268

(22) PCT Filed: Jul. 21, 2015
(86) PCT No.: PCT/US2015/041375

§ 371 Date: Jan. 23, 2017

Related U.S. Application Data
(60) Provisional application No. 62/026,987, filed on Jul. 21, 2014.

(51) Int. Cl. A47J 31/40; B65D 85/804

(52) U.S. Cl. CPC A47J 31/407; B65D 85/8043

(57) ABSTRACT

Systems and methods for processing a composition in a pod to form a food product or beverage fit for oral consumption involve the controlled introduction of various fluids, such as hot and cold water, into the pod to facilitate processing of the composition.

### CROSS-REFERENCE TO RELATED APPLICATIONS

This application claims priority to and any benefit of U.S. Provisional Application No. 62/026,987, filed Jul. 21, 2014, the content of which is incorporated herein by reference in its entirety.

### FIELD

The present disclosure relates generally to nutritional compositions and, more particularly, to systems and methods for rendering a nutritional composition housed in a container suitable for oral consumption, as well as to such containers.

### BACKGROUND

It is known to reconstitute consumable powders with a liquid such as water to render the powders fit for consumption. For example, WO 2006/015689 discloses reconstituting consumable powders with a liquid to provide a food liquid such as milk, cappuccino-type beverage, or soup. The consumable powder is introduced into a container and pre-wetted by introducing a wetting liquid stream into the container such that the wetting liquid stream intersects in mid-air with the powder as the powder is being introduced into the container. The pre-wetted powder is then mixed to form the food liquid by introducing a mixing liquid stream into the container.

### SUMMARY

The general inventive concepts are based, at least in part, on the discovery that controlling, selecting, or otherwise managing one or more parameters associated with one or more input fluid flows can promote more efficient processing of a formulation (e.g., nutritional composition) stored in a sealed container, capsule, or the like (generally, a “pod”). In the case of a powder nutritional composition, this improved processing efficiency can result, for example, in improved mixing of the powder nutritional composition and a reconstituting liquid (e.g., water), a shorter period of time until acceptable reconstitution of the powder nutritional composition occurs, and/or a shorter period of time until an acceptable output temperature of the reconstituted nutritional composition is achieved. In the case of a concentrated liquid nutritional composition, this improved processing efficiency can result, for example, in improved dilution of the concentrated liquid nutritional composition by a diluting liquid (e.g., water), a shorter period of time until acceptable dilution of the concentrated liquid nutritional composition occurs, and/or a shorter period of time until an acceptable output temperature of the diluted nutritional composition is achieved.

The parameters of the input fluid can include, but are not limited to, a volume of the fluid, a temperature of the fluid, a delivery time of the fluid, a flow rate of the fluid, a pressure of the fluid, an input location of the fluid, an input direction of the fluid, and combinations thereof. The type of fluid can be another significant parameter.

In one embodiment, a system for reconstituting a nutritional powder into a nutritional liquid is provided. The system comprises a fluid delivery device and a pod. The pod defines a predetermined volume hermetically enclosing a predetermined quantity of the nutritional powder. The fluid delivery device introduces a volume of a first fluid into the pod at a first temperature and a volume of a second fluid into the pod at a second temperature. At least one of the volume of the first fluid and the volume of the second fluid substantially reconstitutes the nutritional powder to form the nutritional liquid. The nutritional liquid exits the pod at a third temperature.

In some embodiments, the first fluid is liquid water. In some embodiments, the second fluid is liquid water. In some embodiments, the first fluid is steam. In some embodiments, the second fluid is steam. In some embodiments, the first fluid is air. In some embodiments, the second fluid is air. In some embodiments, the first fluid is liquid water and the second fluid is liquid water.

In some embodiments, the first temperature is greater than the second temperature. In some embodiments, the first temperature is less than the second temperature. In some embodiments, the first temperature is greater than the third temperature, and the second temperature is less than the third temperature.

In some embodiments, the first temperature is within the range of 45° C. to 120° C.

In some embodiments, the second temperature is within the range of 5° C. to 20° C. In some embodiments, the second temperature is within the range of 5° C. to 40° C.

In some embodiments, the third temperature is within the range of 25° C. to 50° C. In some embodiments, the third temperature is within the range of 5° C. to 25° C.

In some embodiments, |(the third temperature−the first temperature)|>|(the third temperature−the second temperature)|.

In some embodiments, the fluid delivery device includes means for heating at least one of the first fluid and the second fluid. In some embodiments, the means for heating comprises a heating element.

In some embodiments, the fluid delivery device includes means for cooling at least one of the first fluid and the second fluid. In some embodiments, the means for cooling comprises a heat pump.

In some embodiments, the volume of the first fluid is 10% of the total fluid introduced into the pod, and the volume of the second fluid is 90% of the total fluid introduced into the pod. In some embodiments, the volume of the first fluid is 20% of the total fluid introduced into the pod, and the volume of the second fluid is 80% of the total fluid introduced into the pod. In some embodiments, the volume of the first fluid is 30% of the total fluid introduced into the pod, and the volume of the second fluid is 70% of the total fluid introduced into the pod. In some embodiments, the volume of the first fluid is 40% of the total fluid introduced into the pod, and the volume of the second fluid is 60% of the total fluid introduced into the pod. In some embodiments, the volume of the first fluid is 50% of the total fluid introduced into the pod, and the volume of the second fluid is 50% of the total fluid introduced into the pod. In some embodiments, the volume of the first fluid is 60% of the total fluid introduced into the pod, and the volume of the second fluid is 40% of the total fluid introduced into the pod. In some embodiments, the volume of the first fluid is 70% of the total fluid introduced into the pod, and the volume of the second fluid is 30% of the total fluid introduced into the pod. In some embodiments, the volume of the first fluid is 80% of the total fluid introduced into the pod, and the volume of the second fluid is 20% of the total fluid introduced into the pod. In some embodiments, the volume of the first fluid is 90% of the total fluid introduced into the pod, and the volume of the second fluid is 10% of the total fluid introduced into the pod.

In some embodiments, at least one of the first fluid and the second fluid is water, and the total water introduced into the pod is within the range of 1 fluid ounce to 10 fluid ounces. In some embodiments, at least one of the first fluid and the second fluid is water, and the total water introduced into the pod is 1 fluid ounce. In some embodiments, at least one of the first fluid and the second fluid is water, and the total water introduced into the pod is 2 fluid ounces. In some embodiments, at least one of the first fluid and the second fluid is water, and the total water introduced into the pod is 4 fluid ounces. In some embodiments, at least one of the first fluid and the second fluid is water, and the total water introduced into the pod is 8 fluid ounces. In some embodiments, at least one of the first fluid and the second fluid is water, and the total water introduced into the pod is within the range of 25 ml to 500 ml.

In some embodiments, a ratio of a volume of the nutritional powder to the volume of the pod enclosing the powder is within the range of 0.6:1 to 0.9:1.

In some embodiments, a time to reconstitute the nutritional powder into the nutritional liquid is within the range of 10 seconds to 90 seconds. In some embodiments, a time to reconstitute the nutritional powder into the nutritional liquid is within the range of 30 seconds to 60 seconds. In some embodiments, a time to reconstitute the nutritional powder into the nutritional liquid is less than 60 seconds. In some embodiments, a time to reconstitute the nutritional powder into the nutritional liquid is less than 50 seconds. In some embodiments, a time to reconstitute the nutritional powder into the nutritional liquid is less than 40 seconds. In some embodiments, a time to reconstitute the nutritional powder into the nutritional liquid is less than 30 seconds.

In some embodiments, the volume of the first fluid is introduced into the pod at substantially the same time as the volume of the second fluid.

In some embodiments, the volume of the first fluid contacts the nutritional powder before the volume of the second fluid.

In some embodiments, the volume of the first fluid is introduced into the pod over a first period of time, the volume of the second fluid is introduced into the pod over a second period of time, and the first period of time and the second period of time are separated by a third period of time.

In some embodiments, the first period of time is within the range of 10 seconds to 90 seconds. In some embodiments, the first period of time is within the range of 10 seconds to 60 seconds. In some embodiments, the first period of time is within the range of 10 seconds to 30 seconds. In some embodiments, the first period of time is less than 45 seconds.

In some embodiments, the second period of time is within the range of 10 seconds to 90 seconds. In some embodiments, the second period of time is within the range of 10 seconds to 60 seconds. In some embodiments, the second period of time is within the range of 10 seconds to 30 seconds. In some embodiments, the second period of time is less than 45 seconds.

In some embodiments, the third period of time is within the range of 1 second to 20 seconds. In some embodiments, the third period of time is within the range of 1 second to 10 seconds. In some embodiments, the third period of time is within the range of 1 second to 5 seconds. In some embodiments, the third period of time is less than 5 seconds.

In some embodiments, the volume of the first fluid and the volume of the second fluid are introduced into the pod at substantially the same location.

In some embodiments, the volume of the first fluid is introduced into the pod in a first direction, the volume of the second fluid is introduced into the pod in a second direction, and the first direction and the second direction are substantially parallel to one another.

In some embodiments, the volume of the first fluid is introduced into the pod in a first direction, the volume of the second fluid is introduced into the pod in a second direction, and the first direction and the second direction are substantially perpendicular to one another.

In some embodiments, the volume of the first fluid is introduced into the pod in a first direction, the volume of the second fluid is introduced into the pod in a second direction, and the first direction and the second direction form an angle relative to one another, said angle being less than 90 degrees.

In some embodiments, the volume of the first fluid is introduced into the pod in a first direction, the volume of the second fluid is introduced into the pod in a second direction, and the first direction and the second direction form an angle relative to one another, said angle being greater than 90 degrees.

In some embodiments, the volume of the first fluid is introduced into the pod at a first pressure, the volume of the second fluid is introduced into the pod at a second pressure, and the first pressure and the second pressure are substantially the same.

In some embodiments, the volume of the first fluid is introduced into the pod at a first pressure, the volume of the second fluid is introduced into the pod at a second pressure, and the first pressure is greater than the second pressure.

In some embodiments, the volume of the first fluid is introduced into the pod at a first pressure, the volume of the second fluid is introduced into the pod at a second pressure, and the first pressure is less than the second pressure.

In some embodiments, the first pressure is within the range of 200 mb to 15,000 mb.

In some embodiments, the second pressure is within the range of 200 mb to 15,000 mb.

In some embodiments, the volume of the first fluid is introduced into the pod at a first flow rate, the volume of the second fluid is introduced into the pod at a second flow rate, and the first flow rate and the second flow rate are substantially the same.

In some embodiments, the volume of the first fluid is introduced into the pod at a first flow rate, the volume of the second fluid is introduced into the pod at a second flow rate, and the first flow rate is greater than the second flow rate.

In some embodiments, the volume of the first fluid is introduced into the pod at a first flow rate, the volume of the second fluid is introduced into the pod at a second flow rate, and the first flow rate is less than the second flow rate.

In some embodiments, the first flow rate is within the range of 1 ml/s to 10 ml/s.

In some embodiments, the second flow rate is within the range of 1 ml/s to 10 ml/s.

In some embodiments, the nutritional powder is infant formula.

In some embodiments, the pod encloses 2 g to 150 g of the nutritional powder.

In some embodiments, a bulk density of the nutritional powder is within the range of 0.3 g/cc to 0.8 g/cc.

In some embodiments, the nutritional powder comprises at least one of protein, carbohydrate, and fat. In some embodiments, the nutritional powder comprises protein, carbohydrate, and fat.

In some embodiments, the nutritional powder has an average particle size within the range of 10 microns to 500 microns.

In one embodiment, a system for reconstituting a nutritional powder into a nutritional liquid is provided. The system comprises a fluid delivery device and a pod. The pod defines a predetermined volume hermetically enclosing a predetermined quantity of the nutritional powder. The fluid delivery device introduces a volume of water into the pod over a period of time to reconstitute the nutritional powder into the nutritional liquid. The temperature of the water is varied from a first temperature to a second temperature over the period of time.

In some embodiments, the first temperature is greater than the second temperature. In some embodiments, the first temperature is less than the second temperature.

In some embodiments, the first temperature is within the range of 45° C. to 120° C.

In some embodiments, the second temperature is within the range of 5° C. to 20° C. In some embodiments, the second temperature is within the range of 5° C. to 40° C.

In some embodiments, the fluid delivery device includes means for heating water. In some embodiments, the means for heating water comprises a heating element.

In some embodiments, the fluid delivery device includes means for cooling water. In some embodiments, the means for cooling water comprises a heat pump.

In some embodiments, the nutritional liquid exits the pod at a third temperature.

In some embodiments, the first temperature is greater than the third temperature, and the second temperature is less than the third temperature.

In some embodiments, |(third temperature−first temperature)|>|(third temperature−second temperature)|.

In some embodiments, the third temperature is within the range of 25° C. to 50° C. In some embodiments, the third temperature is within the range of 5° C. to 25° C.

In some embodiments, the fluid delivery device introduces a volume of air into the pod over at least a portion of the period of time. In some embodiments, the volume of air is introduced into the pod at a fourth temperature. In some embodiments, the fourth temperature is between the first temperature and the second temperature. In some embodiments, the fourth temperature is within the range of 17° C. to 40° C.

In some embodiments, the volume of water introduced into the pod is within the range of 1 fluid ounce to 10 fluid ounces. In some embodiments, the volume of water introduced into the pod is 1 fluid ounce. In some embodiments, the volume of water introduced into the pod is 2 fluid ounces. In some embodiments, the volume of water introduced into the pod is 4 fluid ounces. In some embodiments, the volume of water introduced into the pod is 8 fluid ounces. In some embodiments, the volume of water introduced into the pod is within the range of 25 ml to 500 ml.

In some embodiments, a ratio of a volume of the nutritional powder to the volume of the pod enclosing the powder is within the range of 0.6:1 to 0.9:1.

In some embodiments, the period of time is within the range of 10 seconds to 60 seconds. In some embodiments, the period of time is within the range of 20 seconds to 50 seconds. In some embodiments, the period of time is less than 60 seconds. In some embodiments, the period of time is less than 50 seconds. In some embodiments, the period of time is less than 40 seconds. In some embodiments, the period of time is less than 30 seconds.

In some embodiments, a first percentage of the volume of water is introduced into the pod and then a second percentage of the volume of water is introduced into the pod, with a period of delay between the first percentage and the second percentage. In some embodiments, the period of delay is within the range of 1 second to 20 seconds. In some embodiments, the period of delay is within the range of 1 second to 10 seconds. In some embodiments, the period of delay is within the range of 1 second to 5 seconds. In some embodiments, the period of delay is less than 5 seconds.

In some embodiments, a ratio of the period of delay to the period of time is within the range of 0.01:1 to 0.15:1.

In some embodiments, a first percentage of the volume of water is introduced into the pod at a first location and at a first temperature, and a second percentage of the volume of water is introduced into the pod at a second location and at a second temperature. In some embodiments, the first percentage is different from the second percentage, the first location is different from the second location, and the first temperature is different from the second temperature. In some embodiments, the first percentage and the second percentage are substantially the same. In some embodiments, the first temperature and the second temperature are substantially the same. In some embodiments, the first location and the second location are substantially the same.

In some embodiments, the first percentage of the volume of water is introduced into the pod in a first direction, the second percentage of the volume of water is introduced into the pod in a second direction, and the first direction and the second direction are substantially parallel to one another.

In some embodiments, the first percentage of the volume of water is introduced into the pod in a first direction, the second percentage of the volume of water is introduced into the pod in a second direction, and the first direction and the second direction are substantially perpendicular to one another.

In some embodiments, the first percentage of the volume of water is introduced into the pod in a first direction, the second percentage of the volume of water is introduced into the pod in a second direction, and the first direction and the second direction form an angle relative to one another, said angle being less than 90 degrees.

In some embodiments, the first percentage of the volume of water is introduced into the pod in a first direction, the second percentage of the volume of water is introduced into the pod in a second direction, and the first direction and the second direction form an angle relative to one another, said angle being greater than 90 degrees.

In some embodiments, a pressure of the water is varied from a first pressure to a second pressure over the period of time. In some embodiments, the first pressure is greater than the second pressure. In some embodiments, the first pressure is less than the second pressure.

In some embodiments, the first pressure is within the range of 200 mb to 15,000 mb.

In some embodiments, the second pressure is within the range of 200 mb to 15,000 mb.

In some embodiments, a flow rate of the water is varied from a first flow rate to a second flow rate over the period of time. In some embodiments, the first flow rate is greater than the second flow rate. In some embodiments, the first flow rate is less than the second flow rate.

In some embodiments, the first flow rate is within the range of 1 ml/s to 10 ml/s.

In some embodiments, the second flow rate is within the range of 1 ml/s to 10 ml/s.

In some embodiments, the nutritional powder is infant formula.

In some embodiments, the pod encloses 2 g to 150 g of the nutritional powder.

In some embodiments, a bulk density of the nutritional powder is within the range of 0.3 g/cc to 0.8 g/cc.

In some embodiments, the nutritional powder comprises at least one of protein, carbohydrate, and fat. In some embodiments, the nutritional powder comprises protein, carbohydrate, and fat.

In some embodiments, the nutritional powder has an average particle size within the range of 10 microns to 500 microns.

In one embodiment, a method of reconstituting a nutritional powder into a nutritional liquid is provided. The nutritional powder is hermetically sealed in a pod. The method comprises disrupting the pod to form at least one opening therein; introducing a first volume of water into the pod through the at least one opening at a first temperature and a second volume of water into the pod through the at least one opening at a second temperature, wherein at least one of the first volume of water and the second volume of water substantially reconstitutes the nutritional powder to form the nutritional liquid, and discharging the nutritional liquid from the pod through the at least one opening at a third temperature.

In some embodiments, the at least one opening comprises one or more input openings and one or more output openings. In some embodiments, the first volume of water enters the pod through at least one of the one or more input openings, the second volume of water enters the pod through at least one of the one or more input openings, and the nutritional liquid exits the pod through at least one of the one or more output openings.

In some embodiments, disrupting the pod comprises piercing the pod.

In some embodiments, disrupting the pod comprises removing a sealing member from the pod.

In some embodiments, disrupting the pod comprises breaking a frangible portion of the pod.

In some embodiments, disrupting the pod comprises opening a valve associated with a port of the pod.

In some embodiments, a rate of reconstitution of the nutritional powder in the water at the first temperature is greater than the rate of reconstitution of the nutritional powder in the water at the second temperature.

In some embodiments, a time to reconstitute the nutritional powder into the nutritional liquid is within the range of 10 seconds to 90 seconds. In some embodiments, a time to reconstitute the nutritional powder into the nutritional liquid is within the range of 30 seconds to 60 seconds. In some embodiments, a time to reconstitute the nutritional powder into the nutritional liquid is within the range of 10 seconds to 30 seconds. In some embodiments, a time to reconstitute the nutritional powder into the nutritional liquid is less than 60 seconds. In some embodiments, a time to reconstitute the nutritional powder into the nutritional liquid is less than 50 seconds. In some embodiments, a time to reconstitute the nutritional powder into the nutritional liquid is less than 40 seconds. In some embodiments, a time to reconstitute the nutritional powder into the nutritional liquid is less than 30 seconds. In some embodiments, a time to reconstitute the nutritional powder into the nutritional liquid is less than 20 seconds.

In some embodiments, the first temperature is greater than the second temperature. In some embodiments, the first temperature is less than the second temperature. In some embodiments, the first temperature is greater than the third temperature, and the second temperature is less than the third temperature.

In some embodiments, the first temperature is within the range of 45° C. to 120° C.

In some embodiments, the second temperature is within the range of 5° C. to 20° C. In some embodiments, the second temperature is within the range of 5° C. to 40° C.

In some embodiments, the third temperature is within the range of 25° C. to 50° C. In some embodiments, the third temperature is within the range of 5° C. to 25° C.

In some embodiments, (third temperature−first temperature)|>|(third temperature−second temperature)|.

In some embodiments, the method further comprises introducing a volume of air into the pod through the at least one opening. In some embodiments, the volume of air is introduced into the pod after the first volume of water and the second volume of water.

In some embodiments, the volume of air is introduced into the pod at a fourth temperature. In some embodiments, the fourth temperature is between the first temperature and the second temperature. In some embodiments, the fourth temperature is within the range of 17° C. to 40° C.

In some embodiments, the method further comprises heating the first volume of water to the first temperature prior to introducing the first volume of water into the pod.

In some embodiments, the method further comprises cooling the second volume of water to the second temperature prior to introducing the second volume of water into the pod.

In some embodiments, the first volume of water is 10% of the total water introduced into the pod, and the second volume of water is 90% of the total water introduced into the pod. In some embodiments, the first volume of water is 20% of the total water introduced into the pod, and the second volume of water is 80% of the total water introduced into the pod. In some embodiments, the first volume of water is 30% of the total water introduced into the pod, and the second volume of water is 70% of the total water introduced into the pod. In some embodiments, the first volume of water is 40% of the total water introduced into the pod, and the second volume of water is 60% of the total water introduced into the pod. In some embodiments, the first volume of water is 50% of the total water introduced into the pod, and the second volume of water is 50% of the total water introduced into the pod. In some embodiments, the first volume of water is 60% of the total water introduced into the pod, and the second volume of water is 40% of the total water introduced into the pod. In some embodiments, the first volume of water is 70% of the total water introduced into the pod, and the second volume of water is 30% of the total water introduced into the pod. In some embodiments, the first volume of water is 80% of the total water introduced into the pod, and the second volume of water is 20% of the total water introduced into the pod. In some embodiments, the first volume of water is 90% of the total water introduced into the pod, and the second volume of water is 10% of the total water introduced into the pod.

In some embodiments, the total water introduced into the pod is within the range of 1 fluid ounce to 10 fluid ounces. In some embodiments, the total water introduced into the pod is 1 fluid ounce. In some embodiments, the total water introduced into the pod is 2 fluid ounces. In some embodiments, the total water introduced into the pod is 4 fluid ounces. In some embodiments, the total water introduced into the pod is 8 fluid ounces. In some embodiments, the total water introduced into the pod is within the range of 25 ml to 500 ml.

In some embodiments, a ratio of a volume of the nutritional powder to a volume of the pod enclosing the powder is within the range of 0.6:1 to 0.9:1.

In some embodiments, the first volume of water is introduced into the pod at substantially the same time as the second volume of water.

In some embodiments, the first volume of water contacts the nutritional powder before the second volume of water.

In some embodiments, the first volume of water is introduced into the pod over a first period of time, the second volume of water is introduced into the pod over a second period of time, and the first period of time and the second period of time are separated by a third period of time.

In some embodiments, the first period of time is within the range of 10 seconds to 90 seconds. In some embodiments, the first period of time is within the range of 10 seconds to 60 seconds. In some embodiments, the first period of time is within the range of 10 seconds to 30 seconds. In some embodiments, the first period of time is less than 45 seconds.

In some embodiments, the second period of time is within the range of 10 seconds to 90 seconds. In some embodiments, the second period of time is within the range of 10 seconds to 60 seconds. In some embodiments, the second period of time is within the range of 10 seconds to 30 seconds. In some embodiments, the second period of time is less than 45 seconds.

In some embodiments, the third period of time is within the range of 1 second to 20 seconds. In some embodiments, the third period of time is within the range of 1 second to 10 seconds. In some embodiments, the third period of time is within the range of 1 second to 5 seconds. In some embodiments, the third period of time is less than 5 seconds.

In some embodiments, the first volume of water and the second volume of water are introduced into the pod at substantially the same location.

In some embodiments, the first volume of water is introduced into the pod in a first direction, the second volume of water is introduced into the pod in a second direction, and the first direction and the second direction are substantially parallel to one another.

In some embodiments, the first volume of water is introduced into the pod in a first direction, the second volume of water is introduced into the pod in a second direction, and the first direction and the second direction are substantially perpendicular to one another.

In some embodiments, the first volume of water is introduced into the pod in a first direction, the second volume of water is introduced into the pod in a second direction, and the first direction and the second direction form an angle relative to one another, said angle being less than 90 degrees.

In some embodiments, the first volume of water is introduced into the pod in a first direction, the second volume of water is introduced into the pod in a second direction, and the first direction and the second direction form an angle relative to one another, said angle being greater than 90 degrees.

In some embodiments, the first volume of water is introduced into the pod at a first pressure, the second volume of water is introduced into the pod at a second pressure, and the first pressure and the second pressure are substantially the same.

In some embodiments, the first volume of water is introduced into the pod at a first pressure, the second volume of water is introduced into the pod at a second pressure, and the first pressure is greater than the second pressure.

In some embodiments, the first volume of water is introduced into the pod at a first pressure, the second volume of water is introduced into the pod at a second pressure, and the first pressure is less than the second pressure.

In some embodiments, the first pressure is within the range of 200 mb to 15,000 mb.

In some embodiments, the second pressure is within the range of 200 mb to 15,000 mb.

In some embodiments, the first volume of water is introduced into the pod at a first flow rate, the second volume of water is introduced into the pod at a second flow rate, and the first flow rate and the second flow rate are substantially the same.

In some embodiments, the first volume of water is introduced into the pod at a first flow rate, the second volume of water is introduced into the pod at a second flow rate, and the first flow rate is greater than the second flow rate.

In some embodiments, the first volume of water is introduced into the pod at a first flow rate, the second volume of water is introduced into the pod at a second flow rate, and the first flow rate is less than the second flow rate.

In some embodiments, the first flow rate is within the range of 1 ml/s to 10 ml/s.

In some embodiments, the second flow rate is within the range of 1 ml/s to 10 ml/s.

In some embodiments, the nutritional powder is infant formula.

In some embodiments, the pod contains 2 g to 150 g of the nutritional powder.

In some embodiments, a bulk density of the nutritional powder is within the range of 0.3 g/cc to 0.8 g/cc.

In some embodiments, the nutritional powder comprises at least one of protein, carbohydrate, and fat. In some embodiments, the nutritional powder comprises protein, carbohydrate, and fat.

In some embodiments, the nutritional powder has an average particle size within the range of 10 microns to 500 microns.

In one embodiment, a pod for housing a predetermined quantity of a nutritional powder is provided. The pod comprises a body having an upper surface, a lower surface, and one or more walls connecting the upper surface and the lower surface. The body defines an interior volume (e.g., a cavity). The pod hermetically encloses the nutritional powder in the interior volume. The pod includes structure for promoting mixing between a first fluid introduced into the pod at a first temperature, a second fluid introduced into the pod at a second temperature, and the nutritional powder.

In some embodiments, the first fluid is liquid water. In some embodiments, the second fluid is liquid water. In some embodiments, the first fluid is steam. In some embodiments, the second fluid is steam. In some embodiments, the first fluid is air. In some embodiments, the second fluid is air. In some embodiments, the first fluid is liquid water and the second fluid is liquid water.

In some embodiments, the structure includes one or more channels in the interior volume for directing the first fluid in the interior volume.

In some embodiments, the structure includes one or more channels in the interior volume for directing the second fluid in the interior volume.

In some embodiments, the structure includes one or more channels in the interior volume for directing the first fluid in the interior volume, and the structure includes one or more channels in the interior volume for directing the second fluid in the interior volume, wherein the first fluid and the second fluid are directed so as to directly contact one another in the interior volume.

In some embodiments, the structure includes one or more channels in the interior volume for directing the first fluid in the interior volume, and the structure includes one or more channels in the interior volume for directing the second fluid in the interior volume, wherein the first fluid and the second fluid are directed so as to not directly contact one another in the interior volume.

In some embodiments, the structure includes one or more input ports for directing the first fluid into the interior volume. In some embodiments, the one or more input ports and the body form a unitary structure.

In some embodiments, the structure includes one or more input ports for directing the second fluid into the interior volume. In some embodiments, the one or more input ports and the body form a unitary structure.

In some embodiments, the structure includes one or more input ports for directing the first fluid into the interior volume, and the structure includes one or more input ports for directing the second fluid into the interior volume, wherein the first fluid and the second fluid are directed so as to directly contact one another in the interior volume.

In some embodiments, the structure includes one or more input ports for directing the first fluid into the interior volume, and the structure includes one or more input ports for directing the second fluid into the interior volume, the first fluid and the second fluid are directed so as to not directly contact one another in the interior volume.

In some embodiments, the structure reshapes at least one of the first fluid and the second fluid in the interior volume.

In some embodiments, the pod further comprises a filter situated in the interior volume, wherein at least one of the first fluid and the second fluid must pass through the filter to reach the nutritional powder.

In some embodiments, the pod further comprises a plurality of filters. In some embodiments, the filters have different mesh sizes.

In some embodiments, the pod further comprises a first filter situated in the interior volume, and a second filter situated in the interior volume, wherein the first fluid must pass through the first filter to reach the nutritional powder, and wherein the second fluid must pass through the second filter to reach the nutritional powder.

In some embodiments, the pod further comprises one or more internal walls defining at least a first chamber and a second chamber in the interior volume, wherein the nutritional powder is located in the first chamber, and wherein the second chamber is substantially free of nutritional powder. In some embodiments, the one or more internal walls allow heat transfer between the first fluid situated on one side of the internal walls and the second fluid situated on the opposite side of the internal walls.

In some embodiments, the pod further comprises a mixing chamber formed in the interior volume, wherein the first chamber and the second chamber are adjacent to one another, wherein the mixing chamber is situated below the first chamber and the second chamber, and wherein the mixing chamber is operable to receive the first fluid after it passes through the first chamber and the second fluid after it passes through the second chamber.

In some embodiments, the second chamber is situated above the first chamber, and the second chamber acts as a collection chamber. In this manner, the second chamber is operable to receive the first fluid prior to the first fluid entering the first chamber and the second fluid prior to the second fluid entering the first chamber.

In some embodiments, the internal wall separating the first and second chambers can have one or more openings to allow fluid to pass from one side of the wall to the other side. In some embodiments, the internal wall can act to alter (e.g., shape, direct) the fluid passing through the openings. For example, the internal wall can function as a type of diffuser plate.

In some embodiments, the pod further comprises one or more outlet ports for allowing a nutritional liquid formed by substantial reconstitution of the nutritional powder in at least one of the first fluid and the second fluid to exit the pod. In some embodiments, the one or more outlet ports and the body form a unitary structure.

In some embodiments, a ratio of a volume of the nutritional powder to the interior volume of the pod is within the range of 0.6:1 to 0.9:1.

In some embodiments, the upper surface of the body is a seal. In some embodiments, the seal includes a frangible portion that is more readily compromised than other portions of the seal. In some embodiments, the frangible portion becomes compromised at an elevated pressure in the interior volume of the pod. In some embodiments, at least a portion of the seal is removable. In some embodiments, the seal is plastic. In some embodiments, the seal is foil.

In some embodiments, the lower surface of the body is a seal. In some embodiments, the seal includes a frangible portion that is more readily compromised than other portions of the seal. In some embodiments, the frangible portion becomes compromised at an elevated pressure in the interior volume of the pod. In some embodiments, at least a portion of the seal is removable. In some embodiments, the seal is plastic. In some embodiments, the seal is foil.

In some embodiments, the pod further comprises indicia on an exterior surface of the body. In some embodiments, the indicia is printed on the exterior surface of the body. In some embodiments, the indicia is printed on a label and affixed to the exterior surface of the body.

In some embodiments, the indicia provides information on a characteristic of the nutritional powder in the pod. In some embodiments, the characteristic is an expiration date of the nutritional powder.

In some embodiments, the nutritional powder is infant formula.

In some embodiments, the pod encloses 2 g to 150 g of the nutritional powder.

In some embodiments, a bulk density of the nutritional powder is within the range of 0.3 g/cc to 0.8 g/cc.

In some embodiments, the pod encloses a single serving of the nutritional powder.

In some embodiments, the nutritional powder enclosed within the pod has an average shelf life of 6 months to 36 months.

In some embodiments, less than 10% of a total amount of gas sealed in the pod is oxygen.

Other aspects and features of the general inventive concepts will become more readily apparent to those of ordinary skill in the art upon review of the following description of various embodiments in conjunction with the accompanying figures.

### BRIEF DESCRIPTION OF THE FIGURES

FIGS. 1-12 are cross-sectional diagrams of pods and associated fluid flows corresponding to examples 1-12.

FIG. 13 is a cross-sectional diagram of a pod and associated fluid flows for illustrating exemplary input directions.

FIG. 14 is a cross-sectional diagram of a pod, according to one exemplary embodiment.

FIG. 15 is a cross-sectional diagram of a pod, according to one exemplary embodiment.

### DETAILED DESCRIPTION

Several illustrative embodiments will be described in detail with the understanding that the present disclosure merely exemplifies the general inventive concepts. Embodiments encompassing the general inventive concepts may take various forms and the general inventive concepts are not intended to be limited to the specific embodiments described herein.

The term “nutritional composition” as used herein, unless otherwise specified, refers to nutritional powders and concentrated liquids. The nutritional powders may be reconstituted to form nutritional liquids suitable for oral consumption by or oral administration to a human. The concentrated liquids may be diluted or otherwise augmented to form nutritional liquids suitable for oral consumption by or oral administration to a human.

The terms “powder” and “reconstitutable powder” as used herein, unless otherwise specified, each describe a physical form of a composition (including, but not limited to, a nutritional composition), or portion thereof, that is flowable or scoopable and intended to be reconstituted with water or other liquid prior to consumption.

The term “concentrated liquid” as used herein, unless otherwise specified, describes a physical form of a composition (including, but not limited to, a nutritional composition), or portion thereof, in which a concentration of one or more ingredients is higher than intended for oral consumption. By diluting the concentrated liquid with water or other liquid, the concentration of these ingredients or components is reduced to a level intended for oral consumption.

The term “pod” as used herein, unless otherwise specified, refers to a hermetically sealed container including one or more chambers therein, wherein at least one of the chambers defines an internal volume containing a substantially soluble powder or liquid concentrate formulation that when mixed with a liquid, such as water, yields a food product or beverage (including, but not limited to, a nutritional food product or beverage).

The term “render suitable for oral consumption” as used herein, unless otherwise specified, refers to the transformation of a formulation (including, but not limited to, a nutritional composition) from a product form not intended for direct oral consumption to a product form intended for direct oral consumption. For example, reconstituting a reconstitutable powder to form a food product or beverage is considered rendering the reconstitutable powder suitable for oral consumption. As another example, diluting a concentrated liquid to form a food product or beverage is considered rendering the concentrated liquid suitable for oral consumption.

The terms “reconstitute” and “reconstitutable” as used herein, unless otherwise specified, refer to a process by which a powder formulation (e.g., a nutritional powder) is mixed with a liquid, typically water, to form an essentially homogeneous liquid product. Once reconstituted in the liquid, the ingredients of the nutritional powder may be any combination of dissolved, dispersed, suspended, colloidally suspended, emulsified, or otherwise blended within the matrix of the liquid product. Therefore, the resulting reconstituted liquid product, may be characterized as any combination of a solution, a dispersion, a suspension, a colloidal suspension, an emulsion, or a homogeneous blend.

The term “fluid flow” as used herein, unless otherwise specified, refers to movement of a fluid whether in response to manipulation of the fluid or in accordance with natural forces (e.g., gravity) acting thereon. The term “fluid flow” also encompasses movement of a fluid that has been dispersed, reshaped, or otherwise altered, such as by atomization of a stream of liquid water.

The term “hot” as used herein, unless otherwise specified, typically refers to a temperature above ambient (i.e., “room temperature”) conditions. However, in some instances, the term “hot” can also be used for purposes of comparison to mean “less cold” than some other temperature. For example, water having a temperature of 18° C. is relatively “hot” compared to water having a temperature of 3° C.

The term “cold” as used herein, unless otherwise specified, typically refers to a temperature below ambient (i.e., “room temperature”) conditions. However, in some instances, the term “cold” can also be used for purposes of comparison to mean “less hot” than some other temperature. For example, water having a temperature of 30° C. is relatively “cold” compared to water having a temperature of 60° C.

As noted above, a pod is a container that includes one or more chambers therein. A substantially soluble powder or liquid concentrate formulation is housed in at least one of the chambers. The pod can have any size and/or shape suitable for housing the formulation. The pod is hermetically sealed to, for example, protect the enclosed formulation from external contamination and/or retard degradation of the enclosed formulation prior to use.

The pod is used by inserting the pod in or otherwise interfacing the pod with a fluid delivery device. The hermetic seal of the pod is then removed or otherwise disrupted. In some embodiments, the fluid delivery device disrupts the hermetic seal of the pod. For example, the fluid delivery device could use a mechanical means (e.g., a needle) to pierce the pod or some portion (e.g., a seal) thereof. As another example, the fluid delivery device could use a mechanical means (e.g., a moving arm) to lift a sealing member or break a frangible portion of the pod. In some embodiments, merely interfacing the pod with the fluid delivery device will remove or disrupt the hermetic seal of the pod. In some embodiments, the user disrupts the hermetic seal of the pod. For example, the user could manually remove a sealing member or break a frangible portion of the pod.

Once the hermetic seal of the pod is removed or disrupted, the fluid delivery device introduces one or more fluid flows into the pod. In some embodiments, a single fluid flow is introduced into the pod. In some embodiments, two fluid flows are introduced into the pod. In some embodiments, more than two fluid flows are introduced into the pod.

The fluid delivery device may include or otherwise be interfaced with additional systems or units for performing other functions. In some embodiments, the fluid delivery device includes a heating system or unit for heating a fluid, such as by conductive heating, before and/or while introducing the fluid into the pod. In some embodiments, the fluid delivery device includes a cooling system or unit (e.g., a heat pump) for cooling a fluid before and/or while introducing the fluid into the pod.

In some embodiments, the fluid delivery device includes a user interface. The user interface receives input information from a user of the fluid delivery device, such as via a keypad, touch screen, microphone, or any other input device. The user interface also delivers output information to the user of the fluid delivery device, such as via a display screen, speaker, or any other output device. The fluid delivery device can include internal storage, such as memory, for storing the input/output information and any other information (e.g., programs, parameter profiles). The fluid delivery device can be powered by any suitable means (e.g., batteries, electrical outlet).

In some embodiments, the fluid delivery device includes an indicia reader. The indicia reader allows the fluid delivery device to read information printed on or otherwise affixed to the pod (e.g., via a label). The indicia can represent any information relating to or otherwise associated with the pod and/or the formulation therein. For example, the indicia could indicate (or be used to determine) the preferred processing conditions and parameters for the pod and its formulation. The indicia could also be used to determine whether the contents of the pod have expired. For example, if the fluid delivery device determines that the current date is beyond an expiration date printed on the pod, the fluid delivery device could reject the pod (e.g., prevent processing of its contents) as having exceeded its suggested shelf life. In some embodiments, the indicia are presented in a form (e.g., large text) suitable for reading by both a user and the indicia reader of the fluid delivery device. Various technologies could be used by the fluid delivery device to read/process the indicia, such as image processing, near-field communications, RFID, etc.

The fluid delivery device may include a platform or other structure for supporting a container to receive the processed formulation as it exits the pod. In some embodiments, a height of the platform is adjustable to accommodate containers of different sizes.

As the fluid delivery device introduces the fluid flows into the pod, at least one of the fluid flows contacts the formulation enclosed in the pod to render it suitable for oral consumption. In some embodiments, the formulation is a reconstitutable powder. In some embodiments, the formulation is a reconstitutable nutritional composition. In some embodiments, the reconstitutable nutritional powder is infant formula. In some embodiments, the formulation is a concentrated liquid. In some embodiments, the formulation is a concentrated liquid nutritional composition. In some embodiments, the concentrated liquid nutritional composition is a nutritional beverage.

In general, the contents of the pod (such as any of the exemplary formulations described or suggested herein) are intended to be entirely processed (i.e., rendered suitable for oral consumption) immediately after the hermetic seal of the pod is intentionally disrupted to allow the fluid flows therein. Accordingly, the pod will typically be a single-use, disposable container.

The term “initiation time” as used herein, unless otherwise specified, generally refers to the time at which a fluid flow begins to enter the pod. In some embodiments, any delay between the time the hermetic seal of the pod is disrupted and the initiation time is less than 1 second. In some embodiments, any delay between the time the hermetic seal of the pod is disrupted and the initiation time is less than 2 seconds. In some embodiments, any delay between the time the hermetic seal of the pod is disrupted and the initiation time is less than 3 seconds. In some embodiments, any delay between the time the hermetic seal of the pod is disrupted and the initiation time is less than 4 seconds. In some embodiments, any delay between the time the hermetic seal of the pod is disrupted and the initiation time is less than 5 seconds. In some embodiments, a delay between the time the hermetic seal of the pod is disrupted and the initiation time is within the range of 1 second to 10 seconds. In some embodiments, a delay between the time the hermetic seal of the pod is disrupted and the initiation time is within the range of 1 second to 30 seconds.

The term “completion time” as used herein, unless otherwise specified, refers generally to the period of time from the initiation time of the first fluid flow to the time at which substantially all of the formulation has been processed (e.g., reconstituted) and exited the pod. Here, “substantially” all can mean at least 90%, more preferably at least 95%, and most preferably at least 99%. The term “completion time” can also be used to refer generally to the amount of time it takes for a pod to be completely used/processed.

In some embodiments, the completion time is within the range of 10 seconds to 90 seconds. In some embodiments, the completion time is within the range of 30 seconds to 60 seconds. In some embodiments, the completion time is less than 60 seconds. In some embodiments, the completion time is less than 50 seconds. In some embodiments, the completion time is less than 40 seconds. In some embodiments, the completion time is less than 30 seconds.

As the contents of the pod are processed (i.e., rendered suitable for oral consumption), the processed contents will begin to exit the pod, such as through an outlet port or other opening formed in the pod. The term “output location” as used herein, unless otherwise specified, generally refers to a location on the pod at which an opening is formed or otherwise placed in an open state such that the processed contents of the pod can exit the pod through the opening. In some embodiments, the output location is defined by a port or similar structure integrally formed or otherwise interfaced with the pod.

The processed contents typically exit the pod at a temperature that differs from the temperatures of any of the fluid flows introduced into the pod. In particular, the desired temperature of the finished food product or beverage obtained from processing the pod is usually dependent on the product itself.

In some embodiments, the desired temperature of the finished product approximates the average human body temperature, i.e., approximately 37° C. In some embodiments, the desired temperature of the finished product approximates an average “room temperature,” i.e., approximately 21° C. In some embodiments, the desired temperature of the finished product is within the range of 20° C. to 24° C. In some embodiments, the desired temperature of the finished product is within the range of 25° C. to 50° C. In some embodiments, the desired temperature of the finished product is within the range of 5° C. to 25° C.

The pod will typically enclose an amount of a formulation corresponding to a single serving. The amount of the formulation corresponding to a single serving may vary, for example, based on the intended consumer (e.g., a child, an adult, a healthy individual, a sick individual). In some instances, more formulation than needed for a single serving (but less than needed for two full servings) may be included in the pod, such as when an ingredient of the formulation is likely to degrade or otherwise lose effectiveness over time. Accordingly, the dimensions of the pod may vary, as needed, to accommodate different formulation quantities.

In some embodiments, the pod encloses an amount of a reconstitutable powder that reconstitutes into a single serving of a food product or beverage upon application of a predetermined volume of liquid. In some embodiments, the amount of the reconstitutable powder in the pod is within the range of 2 g to 150 g.

In some embodiments, the amount of the reconstitutable powder in the pod is within the range of 2 g to 100 g. In some embodiments, the amount of the reconstitutable powder in the pod is within the range of 2 g to 80 g. In some embodiments, the amount of the reconstitutable powder in the pod is within the range of 2 g to 60 g. In some embodiments, the amount of the reconstitutable powder in the pod is within the range of 2 g to 50 g. In some embodiments, the amount of the reconstitutable powder in the pod is within the range of 2 g to 35 g. In some embodiments, the amount of the reconstitutable powder in the pod is within the range of 2 g to 30 g. In some embodiments, the amount of the reconstitutable powder in the pod is within the range of 2 g to 25 g. In some embodiments, the amount of the reconstitutable powder in the pod is within the range of 2 g to 20 g. In some embodiments, the amount of the reconstitutable powder in the pod is within the range of 2 g to 15 g. In some embodiments, the amount of the reconstitutable powder in the pod is within the range of 2 g to 10 g.

In some embodiments, the amount of the reconstitutable powder in the pod is within the range of 5 g to 100 g. In some embodiments, the amount of the reconstitutable powder in the pod is within the range of 5 g to 80 g. In some embodiments, the amount of the reconstitutable powder in the pod is within the range of 5 g to 60 g. In some embodiments, the amount of the reconstitutable powder in the pod is within the range of 5 g to 50 g. In some embodiments, the amount of the reconstitutable powder in the pod is within the range of 5 g to 35 g. In some embodiments, the amount of the reconstitutable powder in the pod is within the range of 5 g to 30 g. In some embodiments, the amount of the reconstitutable powder in the pod is within the range of 5 g to 25 g. In some embodiments, the amount of the reconstitutable powder in the pod is within the range of 5 g to 20 g. In some embodiments, the amount of the reconstitutable powder in the pod is within the range of 5 g to 15 g.

In some embodiments, the amount of the reconstitutable powder in the pod is within the range of 10 g to 100 g. In some embodiments, the amount of the reconstitutable powder in the pod is within the range of 10 g to 80 g. In some embodiments, the amount of the reconstitutable powder in the pod is within the range of 10 g to 60 g. In some embodiments, the amount of the reconstitutable powder in the pod is within the range of 10 g to 50 g. In some embodiments, the amount of the reconstitutable powder in the pod is within the range of 10 g to 40 g. In some embodiments, the amount of the reconstitutable powder in the pod is within the range of 10 g to 35 g. In some embodiments, the amount of the reconstitutable powder in the pod is within the range of 10 g to 30 g. In some embodiments, the amount of the reconstitutable powder in the pod is within the range of 10 g to 25 g. In some embodiments, the amount of the reconstitutable powder in the pod is within the range of 10 g to 20 g.

In some embodiments, the amount of the reconstitutable powder in the pod is within the range of 15 g to 100 g. In some embodiments, the amount of the reconstitutable powder in the pod is within the range of 15 g to 80 g. In some embodiments, the amount of the reconstitutable powder in the pod is within the range of 15 g to 60 g. In some embodiments, the amount of the reconstitutable powder in the pod is within the range of 15 g to 50 g. In some embodiments, the amount of the reconstitutable powder in the pod is within the range of 15 g to 40 g. In some embodiments, the amount of the reconstitutable powder in the pod is within the range of 15 g to 35 g. In some embodiments, the amount of the reconstitutable powder in the pod is within the range of 15 g to 30 g. In some embodiments, the amount of the reconstitutable powder in the pod is within the range of 15 g to 25 g.

In some embodiments, the amount of the reconstitutable powder in the pod is within the range of 20 g to 100 g. In some embodiments, the amount of the reconstitutable powder in the pod is within the range of 20 g to 80 g. In some embodiments, the amount of the reconstitutable powder in the pod is within the range of 20 g to 60 g. In some embodiments, the amount of the reconstitutable powder in the pod is within the range of 20 g to 50 g. In some embodiments, the amount of the reconstitutable powder in the pod is within the range of 20 g to 40 g. In some embodiments, the amount of the reconstitutable powder in the pod is within the range of 20 g to 35 g. In some embodiments, the amount of the reconstitutable powder in the pod is within the range of 20 g to 30 g.

In some embodiments, the amount of the reconstitutable powder in the pod is within the range of 25 g to 100 g. In some embodiments, the amount of the reconstitutable powder in the pod is within the range of 25 g to 80 g. In some embodiments, the amount of the reconstitutable powder in the pod is within the range of 25 g to 60 g. In some embodiments, the amount of the reconstitutable powder in the pod is within the range of 25 g to 50 g. In some embodiments, the amount of the reconstitutable powder in the pod is within the range of 25 g to 40 g. In some embodiments, the amount of the reconstitutable powder in the pod is within the range of 25 g to 35 g.

In some embodiments, the amount of the reconstitutable powder in the pod is within the range of 30 g to 100 g. In some embodiments, the amount of the reconstitutable powder in the pod is within the range of 30 g to 80 g. In some embodiments, the amount of the reconstitutable powder in the pod is within the range of 30 g to 60 g. In some embodiments, the amount of the reconstitutable powder in the pod is within the range of 30 g to 50 g. In some embodiments, the amount of the reconstitutable powder in the pod is within the range of 30 g to 40 g.

In some embodiments, the amount of the reconstitutable powder in the pod is within the range of 40 g to 100 g. In some embodiments, the amount of the reconstitutable powder in the pod is within the range of 40 g to 80 g. In some embodiments, the amount of the reconstitutable powder in the pod is within the range of 40 g to 60 g. In some embodiments, the amount of the reconstitutable powder in the pod is within the range of 40 g to 50 g.

In some embodiments, the amount of the reconstitutable powder in the pod is within the range of 50 g to 100 g. In some embodiments, the amount of the reconstitutable powder in the pod is within the range of 50 g to 80 g. In some embodiments, the amount of the reconstitutable powder in the pod is within the range of 50 g to 60 g.

In some embodiments, the amount of the reconstitutable powder in the pod is approximately 8 g, 10 g, 12 g, 15 g, 20 g, 25 g, 30 g, 35 g, 40 g, 50 g, 60 g, 80 g, 90 g, 100 g, or 150 g.

In some embodiments, a bulk density of the reconstitutable powder in the pod is within the range of 0.3 g/cc to 0.8 g/cc.

In some embodiments, an average particle size of the reconstitutable powder in the pod is within the range of 10 microns to 500 microns.

In some embodiments, the liquid introduced into the pod to reconstitute the reconstitutable powder is water. In some embodiments, the volume of liquid introduced into the pod to reconstitute the reconstitutable powder is within the range of 1 fluid ounce to 10 fluid ounces. In some embodiments, the volume of liquid introduced into the pod to reconstitute the reconstitutable powder is 1 fluid ounce. In some embodiments, the volume of liquid introduced into the pod to reconstitute the reconstitutable powder is 2 fluid ounces. In some embodiments, the volume of liquid introduced into the pod to reconstitute the reconstitutable powder is 4 fluid ounces. In some embodiments, the volume of liquid introduced into the pod to reconstitute the reconstitutable powder is 8 fluid ounces. In some embodiments, the volume of liquid introduced into the pod to reconstitute the reconstitutable powder is greater than 10 fluid ounces. In some embodiments, the volume of liquid introduced into the pod to reconstitute the reconstitutable powder is within the range of 25 ml to 500 ml.

In some embodiments, a ratio of a volume of the reconstitutable powder to the volume of the pod enclosing the powder is within the range of 0.6:1 to 0.9:1.

In some embodiments, the formulation in the pod (e.g., a nutritional powder or concentrated liquid) comprises at least one of protein, carbohydrate, and fat. In some embodiments, the formulation in the pod (e.g., a nutritional powder or concentrated liquid) comprises protein, carbohydrate, and fat.

The pod will typically have a relatively long shelf life. In some embodiments, the pod has an average shelf life within the range of 6 months to 36 months.

The manner in which the formulation is introduced into the pod and in which the pod is sealed can contribute to the pod having an extended shelf life. The contents of the pod are hermetically sealed therein to prevent contamination and to retard degradation resulting from exposure of the contents to air. The formulation can be introduced into the pod in a manner that limits the entrapped oxygen content. For example, an inert gas (e.g., nitrogen) could be applied during introduction of the formulation into the pod to reduce the amount of oxygen that gets sealed in the pod. In some embodiments, an amount of oxygen gas sealed in the pod is less than 10% of the gas therein. In some embodiments, an amount of oxygen gas sealed in the pod is less than 1% of the gas therein.

The formulation itself can have properties that contribute to the extended shelf life of the pod. For example, the formulation could encapsulate an ingredient to reduce an amount of oxidation that would otherwise occur within the pod.

Other factors can also contribute to the extended shelf life of the pod. For example, the pod may be packaged in one or more external containers (e.g., bags, cartons, boxes) to further protect the contents of the pod during transport and handling.

In some embodiments, the pod encloses an amount of a concentrated liquid that can be diluted into a single serving of a food product or beverage upon application of a predetermined volume of liquid. In some embodiments, a ratio of the finished (i.e., diluted) product to the concentrated liquid is within the range of 2:1 to 3:1. In some embodiments, a volume of the finished product is within the range of 25 ml to 500 ml.

In some embodiments, a ratio of the volume of the concentrated liquid to the volume of the pod enclosing the liquid is within the range of 0.6:1 to 0.9:1.

The general inventive concepts encompass various innovations which improve the efficiency of processing of the formulation enclosed within the pod to render it suitable for oral consumption. In the case of a powder nutritional composition, this improved processing efficiency can result, for example, in improved mixing of the powder nutritional composition and a reconstituting liquid (e.g., water), a shorter period of time until acceptable reconstitution of the powder nutritional composition occurs, and/or a shorter period of time until an acceptable output temperature of the reconstituted nutritional composition is achieved. In the case of a concentrated liquid nutritional composition, this improved processing efficiency can result, for example, in improved dilution of the concentrated liquid nutritional composition by a diluting liquid (e.g., water), a shorter period of time until acceptable dilution of the concentrated liquid nutritional composition occurs, and/or a shorter period of time until an acceptable output temperature of the diluted nutritional composition is achieved.

According to the general inventive concepts, parameters, qualities, or the like of the fluid flows are controlled, selected, or otherwise managed to achieve more efficient processing of the formulation stored in the pod. By way of example, one or more of the following parameters associated with the fluid being introduced into the pod are controlled by the systems and in the methods disclosed herein: the type of fluid, the volume of the fluid, the temperature of the fluid, the delivery time of the fluid, the flow rate of the fluid, the pressure of the fluid, the location at which the fluid enters the pod, the direction in which the fluid enters the pod, and combinations thereof.

Fluid Types

In some embodiments, at least one of the fluid flows is water. In some embodiments, two of the fluid flows are water. In some embodiments, more than two of the fluid flows are water. In some embodiments, all of the fluid flows are water. The water can be in liquid or gaseous (e.g., steam) form.

In some embodiments, at least one of the fluid flows is a liquid other than water. In some embodiments, two of the fluid flows are a liquid other than water. In some embodiments, more than two of the fluid flows are a liquid other than water. In some embodiments, all of the fluid flows are a liquid other than water.

In some embodiments, at least one of the fluid flows is air. In some embodiments, two of the fluid flows are air. In some embodiments, more than two of the fluid flows are air.

In some embodiments, two fluid flows can be combined so as to act or otherwise be controlled as single fluid flow. For example, water and air could be delivered through a single opening at the same time.

Fluid Volumes

The volume of the fluid flows introduced into the pod can be varied or otherwise selected to be different to achieve, or at least contribute to achievement of, the aforementioned improved processing efficiency.

In some embodiments, when a single fluid flow is introduced into the pod, the entire volume of the fluid is introduced continuously. In some embodiments, when a single fluid flow is introduced into the pod, a first percentage of the entire volume of the fluid is introduced into the pod and then a second percentage of the entire volume of the fluid is introduced into the pod, with a pause (i.e., a period of time in which no fluid is being introduced into the pod) between introduction of the first percentage of fluid and introduction of the second percentage of fluid.

In some embodiments, the first percentage of the entire volume of the fluid introduced into the pod is 10% and the second percentage of the entire volume of the fluid introduced into the pod is 90%. In some embodiments, the first percentage of the entire volume of the fluid introduced into the pod is 20% and the second percentage of the entire volume of the fluid introduced into the pod is 80%. In some embodiments, the first percentage of the entire volume of the fluid introduced into the pod is 30% and the second percentage of the entire volume of the fluid introduced into the pod is 70%. In some embodiments, the first percentage of the entire volume of the fluid introduced into the pod is 40% and the second percentage of the entire volume of the fluid introduced into the pod is 60%. In some embodiments, the first percentage of the entire volume of the fluid introduced into the pod is 50% and the second percentage of the entire volume of the fluid introduced into the pod is 50%. In some embodiments, the first percentage of the entire volume of the fluid introduced into the pod is 60% and the second percentage of the entire volume of the fluid introduced into the pod is 40%. In some embodiments, the first percentage of the entire volume of the fluid introduced into the pod is 70% and the second percentage of the entire volume of the fluid introduced into the pod is 30%. In some embodiments, the first percentage of the entire volume of the fluid introduced into the pod is 80% and the second percentage of the entire volume of the fluid introduced into the pod is 20%. In some embodiments, the first percentage of the entire volume of the fluid introduced into the pod is 90% and the second percentage of the entire volume of the fluid introduced into the pod is 10%.

In some embodiments, when a single fluid flow is introduced into the pod, the entire volume of the fluid to be introduced into the pod is separated into more than two distinct portions, with a pause between each pair of consecutive portions. In some embodiments, the pauses are of uniform duration. In some embodiments, the pauses differ in duration. Each distinct portion of a fluid flow could be considered a separate fluid flow.

In some embodiments, when a plurality of fluid flows are introduced into the pod, the fluid flows have the same initiation time (as defined above) and the same delivery time. The term “delivery time” as used herein, unless otherwise specified, generally refers to the period of time over which the fluid flow (i.e., a volume of the fluid) enters the pod. In some embodiments, when a plurality of fluid flows are introduced into the pod, the fluid flows have different initiation times but some overlap in their respective delivery times. In some embodiments, when a plurality of fluid flows are introduced into the pod, the fluid flows have different initiation times and no overlap in their respective delivery times.

Typically, a predetermined volume of fluid is needed to render the formulation enclosed in the pod suitable for oral consumption. The fluid delivery device knows to deliver this needed amount of fluid to the pod, for example, based on user input or by reading or otherwise processing indicia on the pod itself. In some embodiments, the user input is received from interaction between the user and a user interface of the fluid delivery device. In some embodiments, where a range of volumes of fluid will suffice to render the formulation enclosed in the pod suitable for oral consumption, the user may be able to select a desired volume of fluid within the range of acceptable volumes of fluid. For example, by choosing a particular volume of fluid to be introduced into the pod, the user may be able to vary a strength of the resulting food product or beverage. The volume of fluid is introduced into the pod via one or more of the fluid flows.

Fluid Temperatures

The temperature of the fluid flows introduced into the pod can be varied or otherwise selected to be different to achieve, or at least contribute to achievement of, the aforementioned improved processing efficiency.

In some embodiments, when a single fluid flow is introduced into the pod, the temperature of the fluid is varied or otherwise changed over the delivery time of the fluid flow. The variance of the temperature of the fluid over the delivery time can be continuous or periodic. In some embodiments, when a single fluid flow is introduced into the pod, a first portion of the fluid flow is introduced at a first temperature and a second portion of the fluid flow is introduced at a second temperature. In some embodiments, there is a pause (i.e., a period of time in which no fluid is being introduced into the pod) between the delivery time of the first portion of the fluid flow and the delivery time of the second portion of the fluid flow.

In some embodiments, when a single fluid flow is introduced into the pod, the entire volume of the fluid to be introduced into the pod is separated into more than two distinct portions each of which can have a different temperature. Additionally, a pause can occur between each pair of consecutive portions. In some embodiments, the pauses are of uniform duration. In some embodiments, the pauses differ in duration.

In some embodiments, when a plurality of fluid flows are introduced into the pod, the fluid flows have the same initiation time and delivery time but different temperatures. In some embodiments, when a plurality of fluid flows are introduced into the pod, the fluid flows have different initiation times and temperatures but some overlap in their respective delivery times. In some embodiments, when a plurality of fluid flows are introduced into the pod, the fluid flows have different initiation times and temperatures with no overlap in their respective delivery times.

In some embodiments, the fluid delivery device is capable of introducing one or more fluid flows and/or one or more fluid types having different temperatures into the pod. The fluid delivery device can be programmed with a series of temperature profiles corresponding to different formulations and/or pod configurations. In this manner, the fluid delivery device knows what parameter values (e.g., temperatures) are needed for the fluid flows, for example, based on user input (e.g., selection of a preconfigured program corresponding to a particular formulation) or by reading or otherwise processing indicia on the pod itself. The fluid delivery device can include a heating element or system for raising the temperature of the fluid before introducing it into the pod. The fluid delivery device can include a cooling element or system for lowering the temperature of the fluid before introducing it into the pod.

Delivery Times

As noted above, the delivery time of a fluid flow refers to the period of time during which the fluid flow enters the pod. Likewise, the delivery time of a portion of a fluid flow refers to the period of time during which that portion of the fluid flow enters the pod. Thus, in general, a “delivery time” is an amount of time during which a volume of fluid is introduced into the pod.

The delivery times of the fluid flows introduced into the pod can be varied or otherwise selected to be different to achieve, or at least contribute to achievement of, the aforementioned improved processing efficiency.

When a single fluid flow is introduced into the pod, the delivery time of the fluid flow is impacted by parameters such as the flow rate and the pressure acting on the fluid. In some embodiments, these parameters are adjusted to vary the delivery time of the fluid flow based on the particular formulation in the pod.

In some embodiments, when a single fluid flow is introduced into the pod, a first portion of the fluid flow having a first delivery time is introduced at a first temperature and a second portion of the fluid flow having a second delivery time is introduced at a second temperature. In some embodiments, the first delivery time is the same as the second delivery time. In some embodiments, the first delivery time is greater than the second delivery time. In some embodiments, the first delivery time is less than the second delivery time.

In some embodiments, there is a pause (i.e., a period of time in which no fluid is being introduced into the pod) between the first delivery time and the second delivery time. In some embodiments, the duration of the pause is greater than the first delivery time. In some embodiments, the duration of the pause is greater than the second delivery time. In some embodiments, the duration of the pause is greater than the first delivery time and the second delivery time combined.

In some embodiments, when a single fluid flow is introduced into the pod, the entire volume of the fluid to be introduced into the pod is separated into more than two distinct portions each of which can have a different delivery time and temperature. Additionally, a pause can occur between each pair of consecutive portions. In some embodiments, the pauses are of uniform duration. In some embodiments, the pauses differ in duration.

In some embodiments, when a plurality of fluid flows are introduced into the pod, the fluid flows have the same initiation time and delivery time. In some embodiments, when a plurality of fluid flows are introduced into the pod, the fluid flows have different initiation times but some overlap in their respective delivery times. In some embodiments, when a plurality of fluid flows are introduced into the pod, the fluid flows have different initiation times with no overlap in their respective delivery times.

In some embodiments, the fluid delivery device is capable of introducing one or more fluid flows and/or one or more fluid types over different delivery times into the pod. The fluid delivery device can be programmed with a series of delivery time profiles corresponding to different formulations and/or pod configurations. In this manner, the fluid delivery device knows how long (i.e., the delivery time) to introduce each fluid flow into the pod, for example, based on user input (e.g., input of a period of time, selection of a preconfigured program corresponding to a particular formulation) or by reading or otherwise processing indicia on the pod itself. Thus, the fluid delivery device can include time keeping logic or the like.

Fluid Flow Rates

The flow rate of the fluid flows introduced into the pod can be varied or otherwise selected to be different to achieve, or at least contribute to achievement of, the aforementioned improved processing efficiency.

The term “flow rate” as used herein, unless otherwise specified, generally refers to the amount of fluid (gas or liquid) that flows in a given time. The flow rate of a fluid flow can be measured as a volumetric flow rate (e.g., L/s) or a mass flow rate (e.g., kg/s). The flow rates of the fluid flows can be defined, altered, or otherwise controlled in any suitable manner.

In some embodiments, when a single fluid flow is introduced into the pod, the flow rate of the fluid is varied or otherwise changed over the delivery time of the fluid flow. The variance of the flow rate of the fluid over the delivery time can be continuous or periodic. In some embodiments, when a single fluid flow is introduced into the pod, a first portion of the fluid flow is introduced at a first flow rate and a second portion of the fluid flow is introduced at a second flow rate. In some embodiments, there is a pause (i.e., a period of time in which no fluid is being introduced into the pod) between the delivery time of the first portion of the fluid flow and the delivery time of the second portion of the fluid flow.

In some embodiments, when a single fluid flow is introduced into the pod, the entire volume of the fluid to be introduced into the pod is separated into more than two distinct portions each of which can have a different flow rate. Additionally, a pause can occur between each pair of consecutive portions. In some embodiments, the pauses are of uniform duration. In some embodiments, the pauses differ in duration.

In some embodiments, when a plurality of fluid flows are introduced into the pod, the fluid flows have the same initiation time and delivery time but different flow rates. In some embodiments, when a plurality of fluid flows are introduced into the pod, the fluid flows have different initiation times and flow rates but some overlap in their respective delivery times. In some embodiments, when a plurality of fluid flows are introduced into the pod, the fluid flows have different initiation times and flow rates with no overlap in their respective delivery times.

In some embodiments, the fluid delivery device is capable of introducing one or more fluid flows and/or one or more fluid types at different flow rates into the pod. The fluid delivery device can be programmed with a series of flow rate profiles corresponding to different formulations and/or pod configurations. In this manner, the fluid delivery device knows what parameter values (e.g., flow rates) are needed for the fluid flows, for example, based on user input (e.g., selection of a preconfigured program corresponding to a particular formulation) or by reading or otherwise processing indicia on the pod itself.

Fluid Flow Pressures

The pressure applied to fluid flows being introduced into the pod can be varied or otherwise selected to be different to achieve, or at least contribute to achievement of, the aforementioned improved processing efficiency. Various measures of the pressure (i.e., force) acting on the fluid flows can be used, for example, millibars (mb), pound per square inch (psi), or kilopascals (kPa). The pressure can be applied in any suitable manner.

In some embodiments, when a single fluid flow is introduced into the pod, the pressure acting on the fluid is varied or otherwise changed over the delivery time of the fluid flow. The variance of the pressure on the fluid over the delivery time can be continuous or periodic. In some embodiments, when a single fluid flow is introduced into the pod, a first portion of the fluid flow is introduced under a first pressure and a second portion of the fluid flow is introduced under a second pressure. In some embodiments, there is a pause (i.e., a period of time in which no fluid is being introduced into the pod) between the delivery time of the first portion of the fluid flow and the delivery time of the second portion of the fluid flow.

In some embodiments, when a single fluid flow is introduced into the pod, the entire volume of the fluid to be introduced into the pod is separated into more than two distinct portions each of which can have a different pressure. Additionally, a pause can occur between each pair of consecutive portions. In some embodiments, the pauses are of uniform duration. In some embodiments, the pauses differ in duration.

In some embodiments, when a plurality of fluid flows are introduced into the pod, the fluid flows have the same initiation time and delivery time but different pressures. In some embodiments, when a plurality of fluid flows are introduced into the pod, the fluid flows have different initiation times and pressures but some overlap in their respective delivery times. In some embodiments, when a plurality of fluid flows are introduced into the pod, the fluid flows have different initiation times and pressures with no overlap in their respective delivery times.

In some embodiments, the fluid delivery device is capable of introducing one or more fluid flows and/or one or more fluid types at different pressures into the pod. The fluid delivery device can be programmed with a series of pressure profiles corresponding to different formulations and/or pod configurations. In this manner, the fluid delivery device knows what parameter values (e.g., pressures) are needed for the fluid flows, for example, based on user input (e.g., selection of a preconfigured program corresponding to a particular formulation) or by reading or otherwise processing indicia on the pod itself.

Input Locations

The term “input location” as used herein, unless otherwise specified, generally refers to a location on the pod at which an opening is formed or otherwise placed in an open state such that a fluid flow can be introduced into the pod through the opening. In some embodiments, the input location is defined by a port or similar structure integrally formed or otherwise interfaced with the pod.

The particular locations on the pod at which the fluid flows are introduced into the pod can be varied or otherwise selected to be different to achieve, or at least contribute to achievement of, the aforementioned improved processing efficiency. In some embodiments, a plurality of predetermined candidate input locations exist with particular input locations being selected and utilized based on one or more processing considerations (e.g., the formulation type, the serving size of the formulation). In some embodiments, the selected input locations represent a subset of the candidate input locations. In some embodiments, the selected input locations represent all of the candidate input locations.

The input locations can be defined in any manner sufficient to ensure consistent location of the fluid flows when processing pods. For example, an input location can be defined relative to the pod itself, such as on a particular portion (e.g., a side wall) or along a particular axis of the pod. As another example, an input location can be defined relative to another input location, such as above, below, adjacent, or opposite some other input location.

Typically, a single fluid flow will be introduced into the pod at one input location. However, in some embodiments, when a single fluid flow is introduced into the pod, a first portion of the fluid flow is introduced at a first input location and a second portion of the fluid flow is introduced at a second input location with a pause (i.e., a period of time in which no fluid is being introduced into the pod) therebetween lasting at least long enough to relocate the fluid flow from the first input location to the second input location. Accordingly, in some embodiments, the fluid delivery device includes means for closing, occluding, sealing, or otherwise blocking an opening in the pod that was being utilized but is no longer being utilized. For example, an input port having a valve therein could permit introduction of a fluid flow through the port for only as long as the fluid delivery device is providing the fluid flow to that particular input port.

In some embodiments, when a single fluid flow is introduced into the pod, the entire volume of the fluid to be introduced into the pod is separated into more than two distinct portions each of which can be introduced into the pod at a different input location. Additionally, as noted above, a pause will typically occur between each pair of consecutive portions. In some embodiments, the pauses are of uniform duration. In some embodiments, the pauses differ in duration.

In some embodiments, when a plurality of fluid flows are introduced into the pod, the fluid flows have the same initiation time and delivery time but different input locations. In some embodiments, when a plurality of fluid flows are introduced into the pod, the fluid flows have different initiation times and input locations but some overlap in their respective delivery times. In some embodiments, when a plurality of fluid flows are introduced into the pod, the fluid flows have different initiation times and input locations with no overlap in their respective delivery times.

In some embodiments, the fluid delivery device is capable of introducing one or more fluid flows and/or one or more fluid types into the pod at different input locations. The fluid delivery device can be programmed with a series of input location profiles corresponding to different formulations and/or pod configurations. In this manner, the fluid delivery device knows what locations on the pod at which to form/activate openings for introduction of the fluid flows, for example, based on user input (e.g., selection of a preconfigured program corresponding to a particular formulation) or by reading or otherwise processing indicia on the pod itself.

Input Directions

The term “input direction” as used herein, unless otherwise specified, generally refers to an orientation at which a fluid flow is introduced (through an opening) into the pod. In some embodiments, the input direction is defined by an orientation of a port or similar structure integrally formed or otherwise interfaced with the pod.

The particular directions at which fluid flows are introduced into the pod can be varied or otherwise selected to be different to achieve, or at least contribute to achievement of, the aforementioned improved processing efficiency. In some embodiments, a plurality of predetermined candidate input directions exist with particular input directions being selected and utilized based on one or more processing considerations (e.g., the formulation type, the serving size of the formulation). In some embodiments, the selected input directions represent a subset of the candidate input directions. In some embodiments, the selected input directions represent all of the candidate input directions.

The input directions can be defined in any manner sufficient to ensure consistent orientation of the fluid flows when processing pods. For example, an input direction can be defined relative to the pod itself, such as perpendicular to a particular axis of the pod. As another example, an input direction can be defined relative to another input direction, such as parallel to, perpendicular to, or intersecting with some other input direction. In some embodiments, an angle can be used to define the relationship between an input direction and some feature (e.g., axis) of the pod or some other input direction.

Typically, a single fluid flow will be introduced into the pod at one input direction. However, in some embodiments, when a single fluid flow is introduced into the pod, a first portion of the fluid flow is introduced at a first input direction and a second portion of the fluid flow is introduced at a second input direction with a pause (i.e., a period of time in which no fluid is being introduced into the pod) therebetween lasting at least long enough to reorient the fluid flow from the first input direction to the second input direction. Accordingly, in some embodiments, the fluid delivery device includes means for orienting or otherwise directing a fluid flow through an opening in the pod. For example, the fluid delivery device could orient or otherwise reposition a flexible input port on the pod to change an input direction of a fluid flow through the port.

In some embodiments, when a single fluid flow is introduced into the pod, the entire volume of the fluid to be introduced into the pod is separated into more than two distinct portions each of which can be introduced into the pod at a different input direction. Additionally, as noted above, a pause will typically occur between each pair of consecutive portions. In some embodiments, the pauses are of uniform duration. In some embodiments, the pauses differ in duration.

In some embodiments, when a plurality of fluid flows are introduced into the pod, the fluid flows have the same initiation time and delivery time but different input directions. In some embodiments, when a plurality of fluid flows are introduced into the pod, the fluid flows have different initiation times and input directions but some overlap in their respective delivery times. In some embodiments, when a plurality of fluid flows are introduced into the pod, the fluid flows have different initiation times and input directions with no overlap in their respective delivery times.

In some embodiments, the fluid delivery device is capable of introducing one or more fluid flows and/or one or more fluid types into the pod at different input directions. The fluid delivery device can be programmed with a series of input direction profiles corresponding to different formulations and/or pod configurations. In this manner, the fluid delivery device knows what directions at which to introduce the fluid flows, for example, based on user input (e.g., selection of a preconfigured program corresponding to a particular formulation) or by reading or otherwise processing indicia on the pod itself

In addition to the exemplary fluid parameters described above, other fluid parameters can also be controlled, selected, or otherwise managed to achieve more efficient processing of the formulation stored in the pod. For example, the direction in which the fluid exits the pod (i.e., output direction) may contribute to the aforementioned processing improvements.

The general inventive concepts contemplate that any suitable method of manufacturing can be used to produce the formulations to be included in the pods. By way of example, nutritional compositions may be manufactured by any known or otherwise suitable method for making nutritional compositions.

In the case of a reconstitutable nutritional powder, such as a spray dried nutritional powder or dry-mixed nutritional powder, the formulation may be prepared by any collection of known or otherwise effective techniques suitable for making and formulating a nutritional powder. For example, when the nutritional powder is a spray dried nutritional powder, the spray drying step may likewise include any spray drying technique that is known for or otherwise suitable for use in the production of nutritional powders. Many different spray drying methods and techniques are known for use in the nutrition field, all of which are suitable for use in the manufacture of the spray dried nutritional powders herein.

One method of preparing the spray dried nutritional powder comprises forming and homogenizing an aqueous slurry or liquid comprising any desired ingredients (e.g., protein, carbohydrate, and fat), and then spray drying the slurry or liquid to produce a spray dried nutritional powder. The method may further comprise the step of spray drying, dry mixing, or otherwise adding additional nutritional ingredients, including any one or more of the ingredients described herein, to the spray dried nutritional powder.

The general inventive concepts contemplate that various formulations and product forms can benefit from the innovative systems, methods, and pods described and suggested herein. By way of example, the formulations useful in the systems and methods of the present disclosure may be formulated in any known or otherwise suitable product form for oral administration. Oral product forms allow for safe and effective oral delivery of the essential and other selected ingredients from the selected product form. In some embodiments, the formulation is a solid nutritional composition, such as a powder, agglomerated powder, granulated solid, or the like. In some embodiments, the formulation is a liquid nutritional composition, such as a concentrated liquid. In some embodiments, the formulation is a semi-solid or semi-liquid composition, such as a pudding or gel.

Typically, the formulation in the pod is not suitable for direct oral consumption. However, after processing, the formulation exits the pod as a liquid food product or beverage (individually and collectively referred to as a “processed formulation”) suitable for direct oral consumption. In some embodiments, the processed formulation is a snack or meal replacement product. In some embodiments, the processed formulation is a hot or cold beverage. In some embodiments, the processed formulation is a carbonated or non-carbonated beverage. In some embodiments, the processed formulation is a juice or other acidified beverage. In some embodiments, the processed formulation is a milk or soy-based beverage. In some embodiments, the processed formulation is milk. In some embodiments, the processed formulation is infant formula. In some embodiments, the processed formulation is a shake. In some embodiments, the processed formulation is a coffee or coffee-based beverage. In some embodiments, the processed formulation is a tea or tea-based beverage. In some embodiments, the processed formulation is a soup. In some embodiments, the processed formulation is a soup.

When the formulation is a nutritional composition, the nutritional composition may be formulated with sufficient kinds and amounts of nutrients to provide a sole, primary, or supplemental source of nutrition, or to provide a specialized nutritional product having a targeted nutritional benefit such as for use in individuals afflicted with specific diseases or conditions.

In some embodiments, the nutritional compositions may comprise one or more optional macronutrients. The optional macronutrients include proteins, carbohydrates, fats, and combinations thereof. In some embodiments, the nutritional compositions comprise at least one protein, at least one carbohydrate, and at least one fat.

Macronutrients suitable for use herein include any protein, carbohydrate, or fat (lipid), or source thereof, that is known for or otherwise suitable for use in a processed formulation intended for oral consumption, provided that the optional macronutrient is also compatible with the other ingredients in the nutritional composition.

The concentration or amount of optional protein, carbohydrate, and fat in the nutritional composition can vary considerably depending upon the particular nutritional application of the product. By way of example only, these optional macronutrients can be formulated within any of the embodied ranges described in Tables 1 and 2 below.

TABLE 1

| Nutrient (% total | | | |
|---|---|---|---|
| calories) | Example A | Example B | Example C |
| Protein | 0-100 | 5-40 | 15-25 |
| Carbohydrate | 0-100 | 10-70 | 40-50 |
| Fat | 0-100 | 20-65 | 35-55 |

Each numerical value preceded by the term “about.”

TABLE 2

| Nutrient (wt % | | | |
|---|---|---|---|
| composition) | Example D | Example E | Example F |
| Protein | 0-98 | 1-30 | 2-10 |
| Carbohydrate | 0-98 | 1-50 | 10-30 |
| Fat | 0-98 | 1-30 | 3-15 |

Each numerical value preceded by the term “about.”

Optional proteins suitable for use in the nutritional compositions include hydrolyzed, partially hydrolyzed or non-hydrolyzed proteins or protein sources, and can be derived from any known or otherwise suitable source such as milk (e.g., casein, whey), animal (e.g., meat, fish, egg albumen), cereal (e.g., rice, corn), vegetable (e.g., soy, pea, potato), or combinations thereof. The proteins for use herein can also include, or be entirely or partially replaced by, free amino acids known for use in nutritional compositions, non-limiting examples of which include L-tryptophan, L-glutamine, L-tyrosine, L-methionine, L-cysteine, taurine, L-arginine, L-carnitine, and combinations thereof.

Optional carbohydrates suitable for use in the nutritional compositions may be simple, complex, or variations or combinations thereof, all of which are optionally in addition to the metal amino acid chelates as described herein. Non-limiting examples of suitable carbohydrates include hydrolyzed or modified starch or cornstarch, maltodextrin, isomaltulose, sucromalt, glucose polymers, sucrose, corn syrup, corn syrup solids, rice-derived carbohydrate, glucose, fructose, lactose, high fructose corn syrup, honey, sugar alcohols (e.g., maltitol, erythritol, sorbitol), and combinations thereof.

Optional carbohydrates suitable for use in the nutritional compositions also include soluble dietary fiber, non-limiting examples of which include gum Arabic, fructooligosaccharide (FOS), sodium carboxymethyl cellulose, guar gum, citrus pectin, low and high methoxy pectin, oat and barley glucans, carrageenan, psyllium and combinations thereof. Insoluble dietary fiber is also suitable as a carbohydrate source herein, non-limiting examples of which include oat hull fiber, pea hull fiber, soy hull fiber, soy cotyledon fiber, sugar beet fiber, cellulose, corn bran, and combinations thereof.

Optional fats suitable for use in the nutritional compositions include coconut oil, fractionated coconut oil, soy oil, corn oil, olive oil, safflower oil, high oleic safflower oil, high GLA-safflower oil, MCT oil (medium chain triglycerides), sunflower oil, high oleic sunflower oil, palm and palm kernel oils, palm olein, canola oil, flaxseed oil, borage oil, soybean oil, cottonseed oils, evening primrose oil, blackcurrant seed oil, transgenic oil sources, fungal oils, marine oils (e.g., tuna, sardine), and combinations thereof.

The nutritional compositions may further comprise other optional ingredients that may modify the physical, nutritional, chemical, hedonic or processing characteristics of the formulations or serve as pharmaceutical or additional nutritional components when used in a targeted population. Many such optional ingredients are known or otherwise suitable for use in other nutritional compositions and may also be used in the nutritional compositions described herein, provided that such optional ingredients are safe and effective for oral consumption and are compatible with the essential and other ingredients in the selected product form.

Non-limiting examples of such optional ingredients include preservatives, antioxidants, emulsifying agents, buffers, fructooligosaccharides, pharmaceutical actives, additional nutrients as described herein, colorants, flavors, thickening agents and stabilizers, and so forth.

The nutritional compositions may further comprise vitamins or related nutrients, non-limiting examples of which include vitamin A, vitamin D, vitamin E, vitamin K, thiamine, riboflavin, pyridoxine, vitamin B12, carotenoids, niacin, folic acid, pantothenic acid, biotin, vitamin C, choline, inositol, salts, and derivatives thereof, and combinations thereof.

The nutritional compositions may further comprise additional minerals, non-limiting examples of which include phosphorus, magnesium, calcium, sodium, potassium, molybdenum, chromium, selenium, chloride, and combinations thereof.

The nutritional compositions may also include one or more flavoring or masking agents. Suitable flavoring or masking agents include natural and artificial sweeteners, sodium sources such as sodium chloride, and hydrocolloids, such as guar gum, xanthan gum, carrageenan, gellan gum, gum acacia and combinations thereof.

### EXAMPLES

The following examples, which illustrate specific embodiments and/or features, are provided solely for the purposes of promoting a better overall understanding of the general inventive concepts. Accordingly, the following examples are not to be construed as limitations of the general inventive concepts, as many variations thereof are possible without departing from the spirit and scope of the general inventive concepts.

The following examples are presented as cross-sectional diagrams of exemplary pods in which various structural and/or functional features are shown and described.

### Example 1

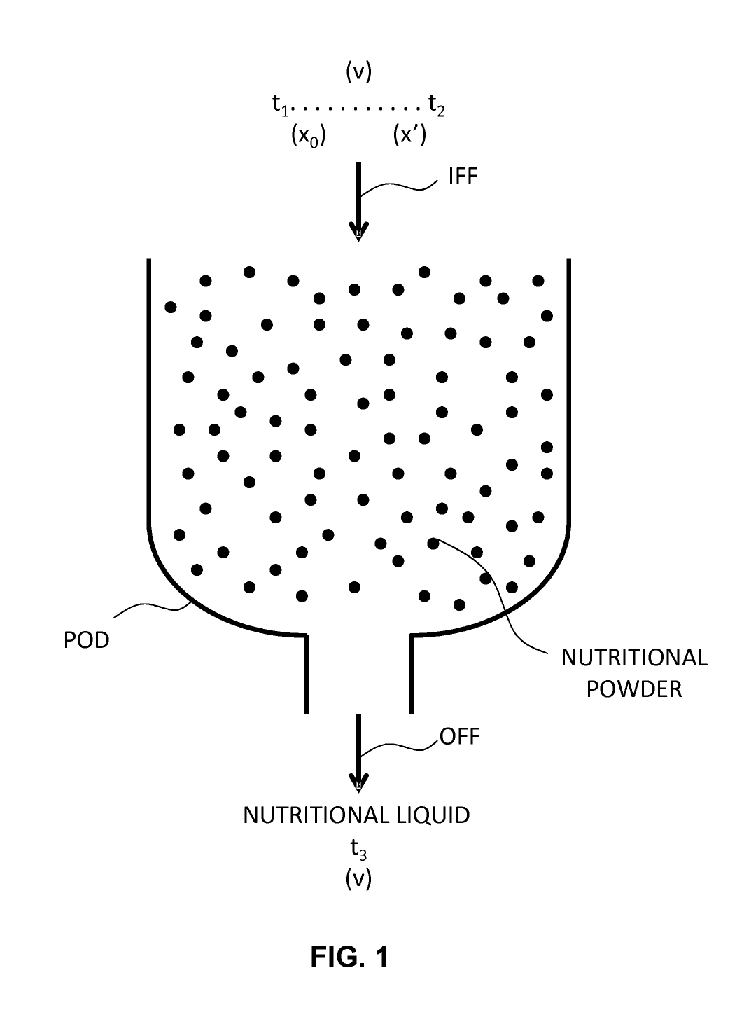

In example 1, as shown in FIG. 1, a single input fluid flow (IFF) is introduced into a pod containing a nutritional powder. The IFF represents a volume v of a fluid (e.g., water) entering the pod. Ideally, the same volume v of the fluid would also exit the pod, as an output fluid flow (OFF). The OFF includes the reconstituted nutritional powder.

In this example, a temperature of the IFF is varied or changed from a first temperature t₁ to a second temperature t₂ over a period of time from x₀ to x′. Here, x₀ is the initiation time of the IFF. The period of time (i.e., x₀ to x′) is the delivery time of the IFF. Because the volume v of the fluid is introduced into the pod at different temperatures (i.e., t₁ and t₂), the OFF will typically have a temperature t₃ that is between t₁ and t₂. In this manner, the benefits of using a particular temperature (e.g., a high temperature) fluid can be obtained, while still obtaining a product having a desired output temperature.

### Example 2

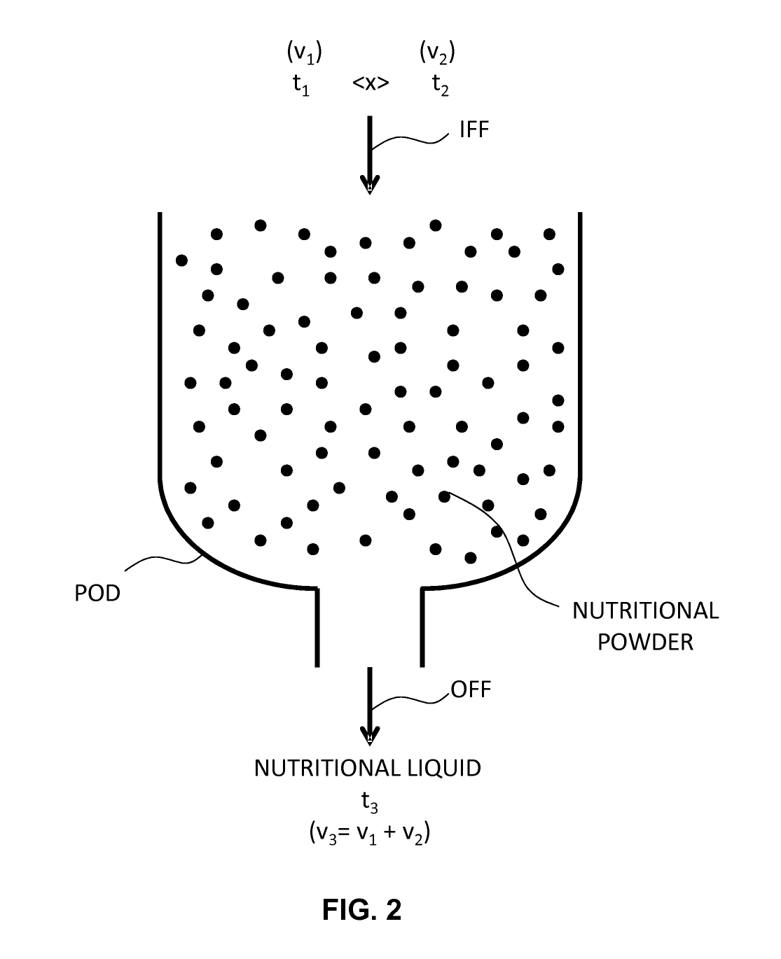

In example 2, as shown in FIG. 2, a single input fluid flow (IFF) is introduced into a pod containing a nutritional powder. The IFF represents a first volume v₁ of a fluid (e.g., water) entering the pod and a second volume v₂ of the fluid entering the pod. In this example, v₁≠v₂. Ideally, the same volume v₃ (where v₃=v₁+v₂) of the fluid would also exit the pod, as an output fluid flow (OFF). The OFF includes the reconstituted nutritional powder.

In this example, the first volume v₁ of the fluid has a first temperature t₁ as it enters the pod and the second volume v₂ of the fluid has a second temperature t₂ as it enters the pod. In this example, t₁≠t₂. Here, a period of time <x> represents a pause or delay. Thus, <x> is a period of time, such as 5 seconds, situated between the delivery time of the first portion of the IFF corresponding to the first volume v₁ of the fluid and the delivery time of the second portion of the IFF corresponding to the second volume v₂ of the fluid. Because the volumes v₁ and v₂ of the fluid are introduced into the pod at different temperatures (i.e., t₁ and t₂), the OFF will typically have a temperature t₃ that is between t₁ and t₂. In this manner, the benefits of using a particular volume of the fluid having a particular temperature (e.g., a high temperature) fluid can be obtained, while still obtaining a product having a desired output temperature.

### Example 3

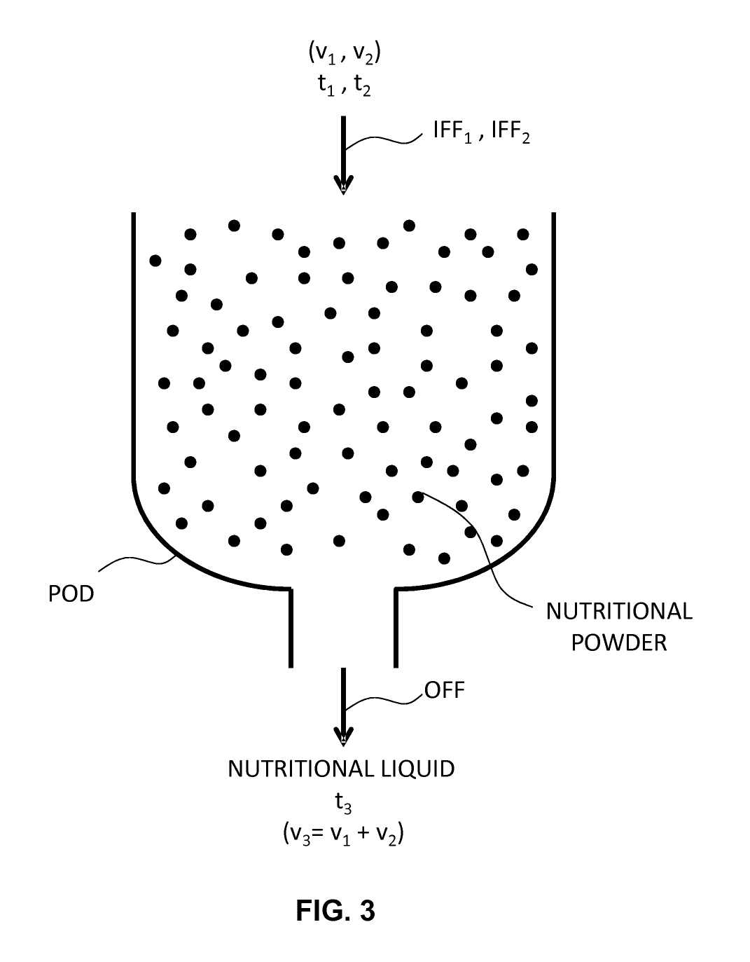

In example 3, as shown in FIG. 3, two input fluid flows (IFF₁ and IFF₂) are introduced into a pod containing a nutritional powder. The IFF₁ represents a volume v₁ of a first fluid (e.g., water) entering the pod. The IFF₂ represents a volume v₂ of a second fluid (e.g., water) entering the pod. In this example, v₁≠v₂. Ideally, the same volume v₃ (where v₃=v₁+v₂) of fluid would also exit the pod, as an output fluid flow (OFF). The OFF includes the reconstituted nutritional powder.

In this example, The IFF₁ and the IFF₂ are separate input fluid flows being introduced into the pod at the same input location. In this example, the IFF₁ and the IFF₂ begin being introduced into the pod at the same time (i.e., have the same initiation time).

In this example, the IFF₁ has a temperature t₁ as it enters the pod and the IFF₂ has a temperature t₂ as it enters the pod. Because the volumes v₁ and v₂ of the input fluid flows IFF₁, IFF₂ are introduced into the pod at different temperatures (i.e., t₁ and t₂), the OFF will typically have a temperature t₃ that is between t₁ and t₂. In this manner, the benefits of using particular volumes of particular fluids having particular temperatures can be obtained, while still obtaining a product having a desired output temperature. For example, the values of v₁, v₂, t₁, and t₂ can be adjusted to obtain desired processing characteristics and/or the desired output temperature.

### Example 4

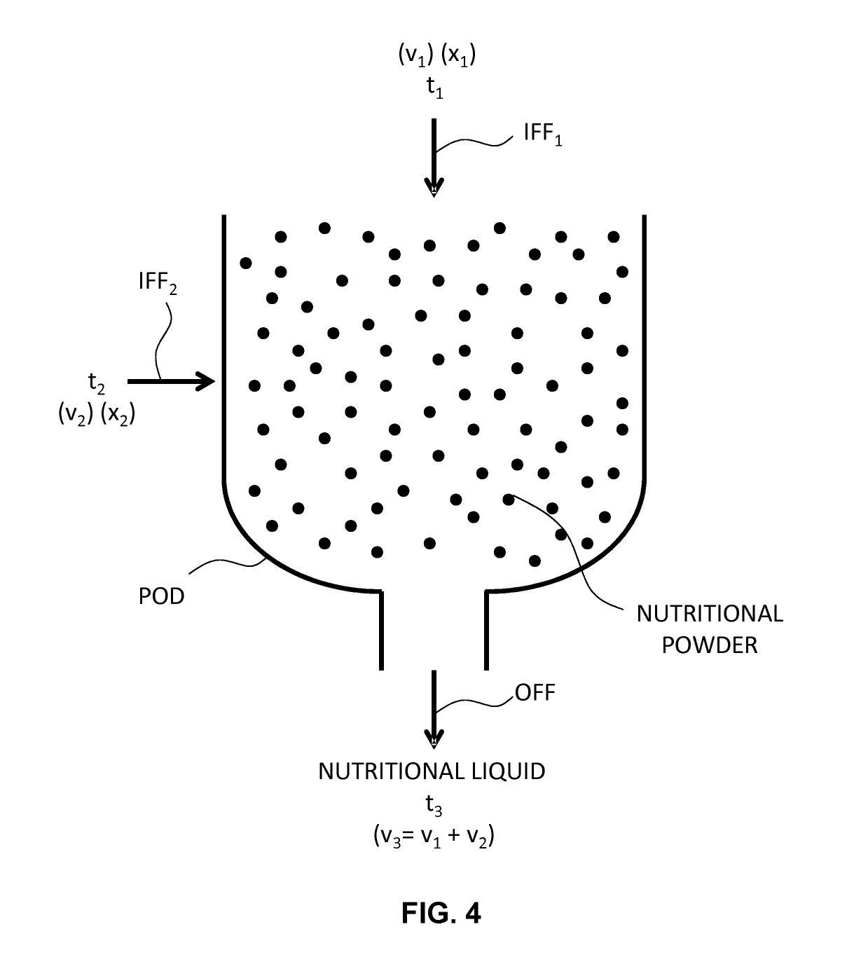

In example 4, as shown in FIG. 4, two input fluid flows (IFF₁ and IFF₂) are introduced into a pod containing a nutritional powder. The IFF₁ represents a volume v₁ of a first fluid (e.g., water) entering the pod. The IFF₂ represents a volume v₂ of a second fluid (e.g., water) entering the pod. In this example, v ₁≠v₂. Ideally, the same volume v₃ (where v₃=v₁+v₂) of fluid would also exit the pod, as an output fluid flow (OFF). The OFF includes the reconstituted nutritional powder.

In this example, The IFF₁ and the IFF₂ are separate input fluid flows being introduced into the pod at different input locations. In this example, the IFF₁ and the IFF₂ begin being introduced into the pod at different times (i.e., have different initiation times x₁, and x₂).

In this example, the IFF₁ has a temperature t₁ as it enters the pod and the IFF₂ has a temperature t₂ as it enters the pod. Because the volumes v₁ and v₂ of the input fluid flows IFF₁, IFF₂ are introduced into the pod at different temperatures (i.e., t₁ and t₂), the OFF will typically have a temperature t₃ that is between t₁ and t₂. In this manner, the benefits of using particular volumes of particular fluids having particular temperatures can be obtained, while still obtaining a product having a desired output temperature. For example, the values of v₁, v₂, t₁, t₂, x₁, and x₂ can be adjusted to obtain desired processing characteristics and/or the desired output temperature.

### Example 5

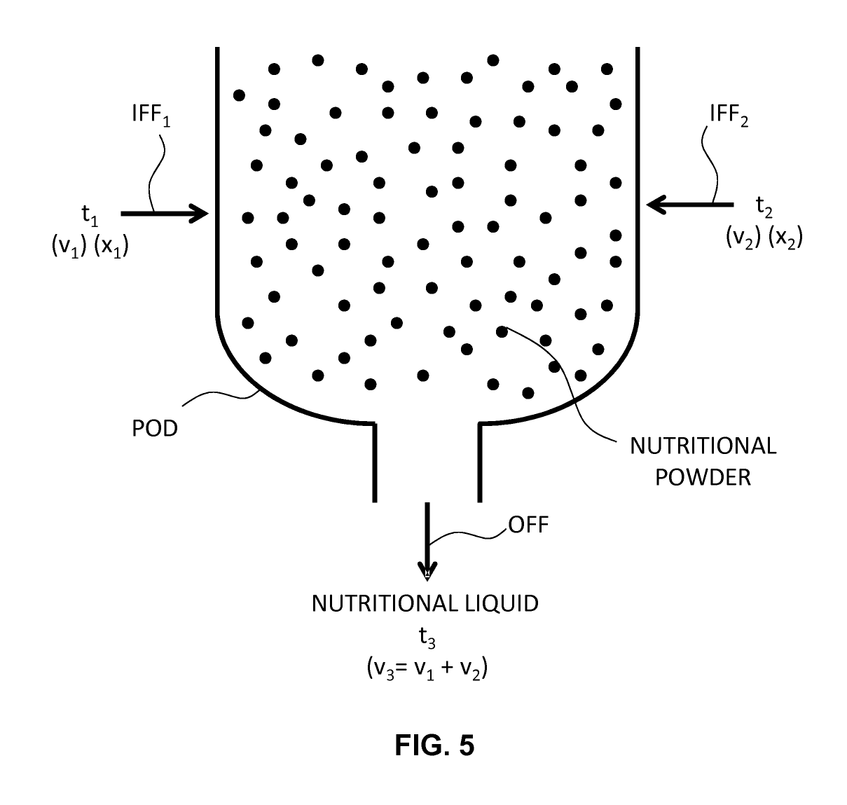

Example 5, as shown in FIG. 5, is similar to example 4 but with separate input fluid flows IFF₁ and IFF₂ being introduced into the pod at input locations on opposite sides of the pod.

### Example 6

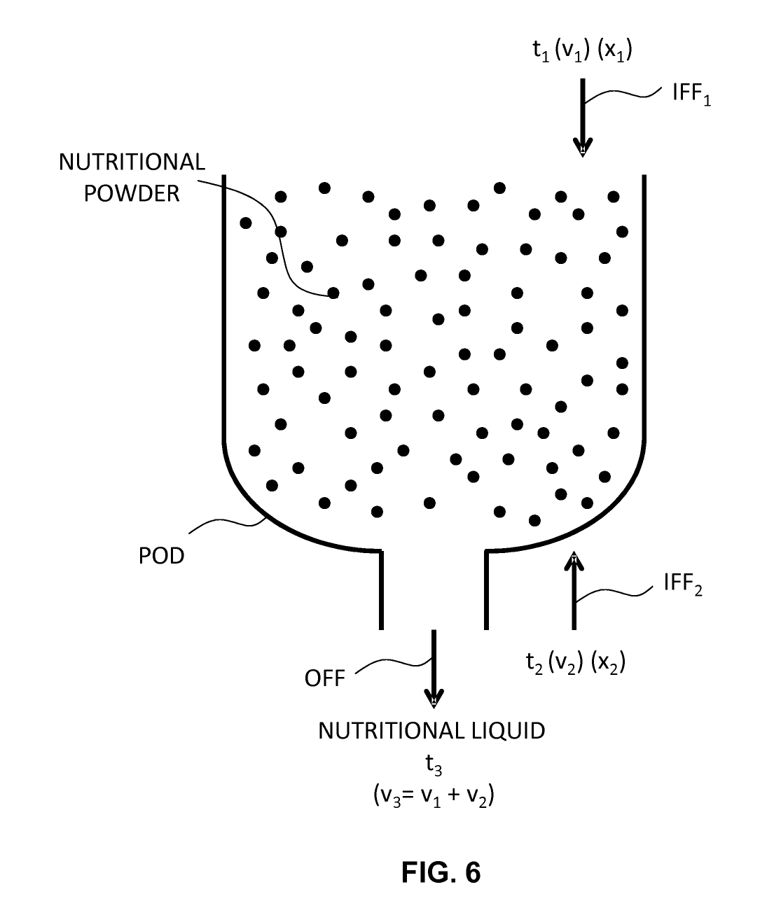

Example 6, as shown in FIG. 6, is similar to example 5 but with separate input fluid flows IFF₁ and IFF₂ being introduced into the pod at input locations on opposite sides of the pod, with one of the input locations (i.e., for IFF₂) being on the same side of the pod as the output location for the output fluid flow OFF.

### Example 7

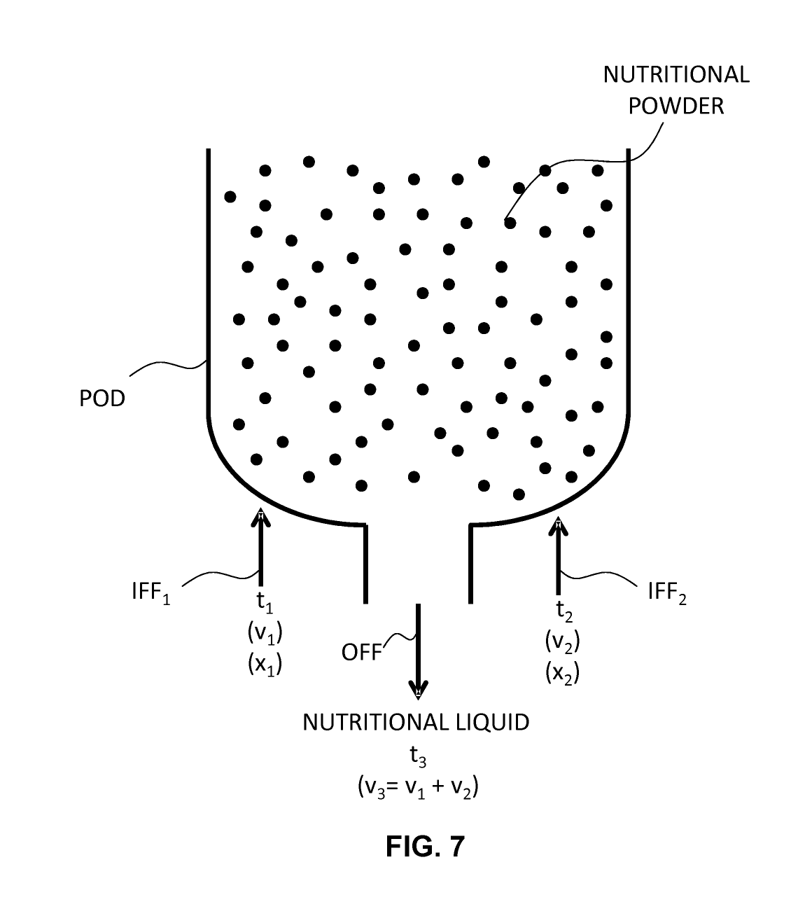

Example 7, as shown in FIG. 7, is similar to example 5 but with separate input fluid flows IFF₁ and IFF₂ being introduced into the pod at input locations on the same side of the pod, with both of the input locations (i.e., for IFF₁ and IFF₂) being on the same side of the pod as the output location for the output fluid flow OFF.

### Example 8

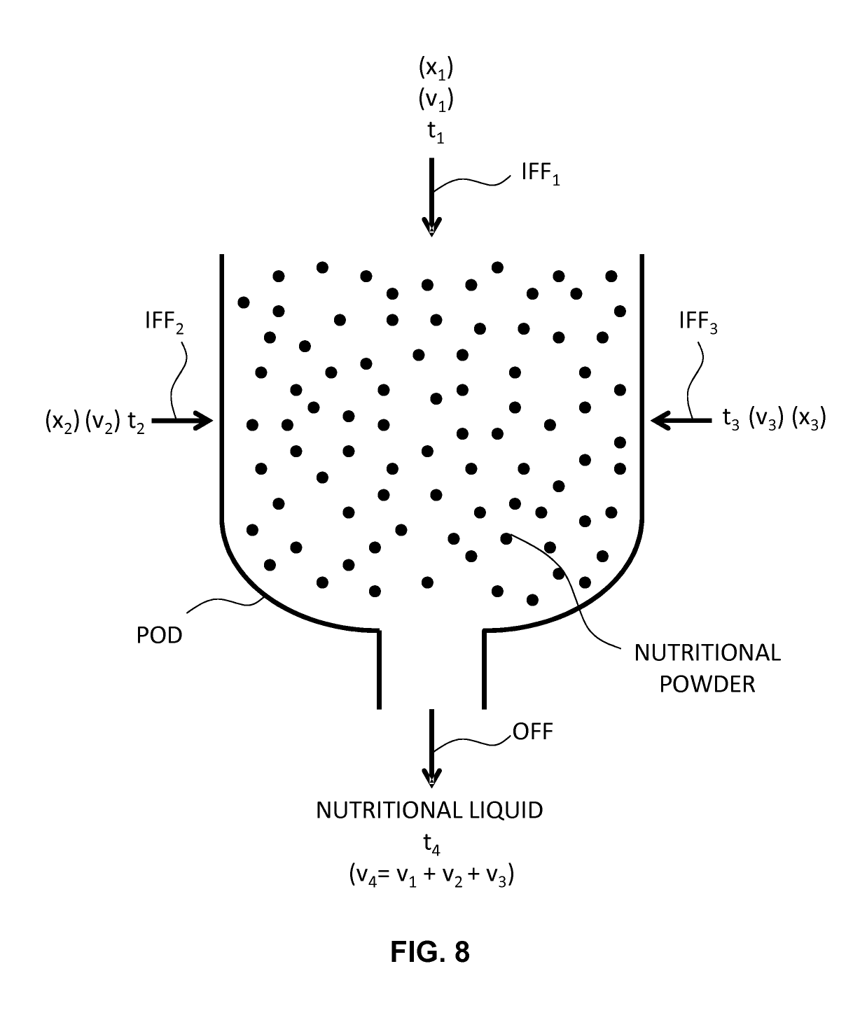

In example 8, as shown in FIG. 8, three input fluid flows (IFF₁, IFF₂, and IFF₃) are introduced into a pod containing a nutritional powder. The IFF₁ represents a volume v₁ of a first fluid (e.g., water) entering the pod. The IFF₂ represents a volume v₂ of a second fluid (e.g., water) entering the pod. The IFF₃ represents a volume v₃ of a third fluid (e.g., water) entering the pod. In this example, v₁≠v₂, v₁≠v₃, and v₂≠v₃. Ideally, the same volume v₄ (where v₄=v₁+v₂+v₃) of fluid would also exit the pod, as an output fluid flow (OFF). The OFF includes the reconstituted nutritional powder.

In this example, the IFF₁, the IFF₂, and the IFF₃ are separate input fluid flows being introduced into the pod at different input locations. In this example, each of the IFF₁, the IFF₂, and the IFF₃ have an input location on a different side of the pod, with all of the input locations being on different sides of the pod from the output location for the output fluid flow OFF. In this example, the IFF₁, the IFF₂, and the IFF₃ begin being introduced into the pod at different times (i.e., have different initiation times x₁, x₂, and x₃).

In this example, the IFF₁ has a temperature t₁ as it enters the pod, the IFF₂ has a temperature t₂ as it enters the pod, and the IFF₃ has a temperature t₃ as it enters the pod. Because the volumes v₁, v₂, and v₃ of the input fluid flows IFF₁, IFF₂, and IFF₃ are introduced into the pod at different temperatures (i.e., t₁, t₂, and t₃), the OFF will typically have a temperature t₄ that is between the highest and lowest of these temperatures. In this manner, the benefits of using particular volumes of particular fluids having particular temperatures can be obtained, while still obtaining a product having a desired output temperature. For example, the values of v₁, v₂, v₃, t₁, t₂, t₃, x₁, x₂, and x₃ can be adjusted to obtain desired processing characteristics and/or the desired output temperature.

### Example 9

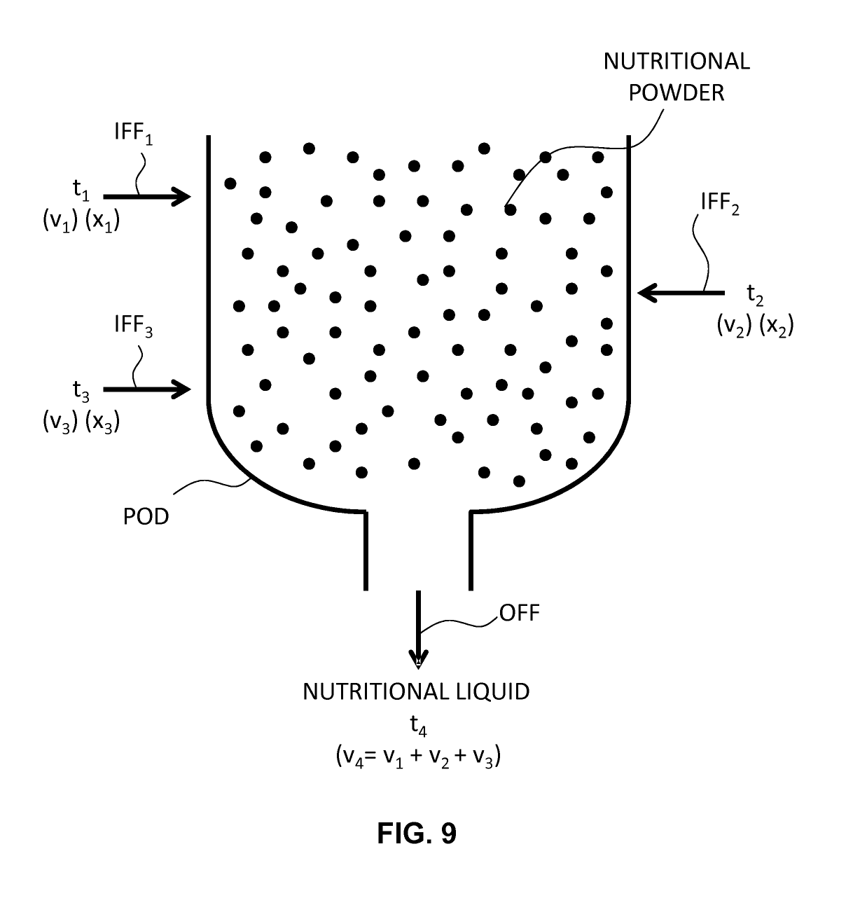

Example 9, as shown in FIG. 9, is similar to example 8 but with two separate input fluid flows IFF₁ and IFF₃ being introduced into the pod at different input locations on the same side of the pod, and with one separate fluid flow IFF₂ being introduced into the pod at a different input location on the opposite side of the pod.

### Example 10

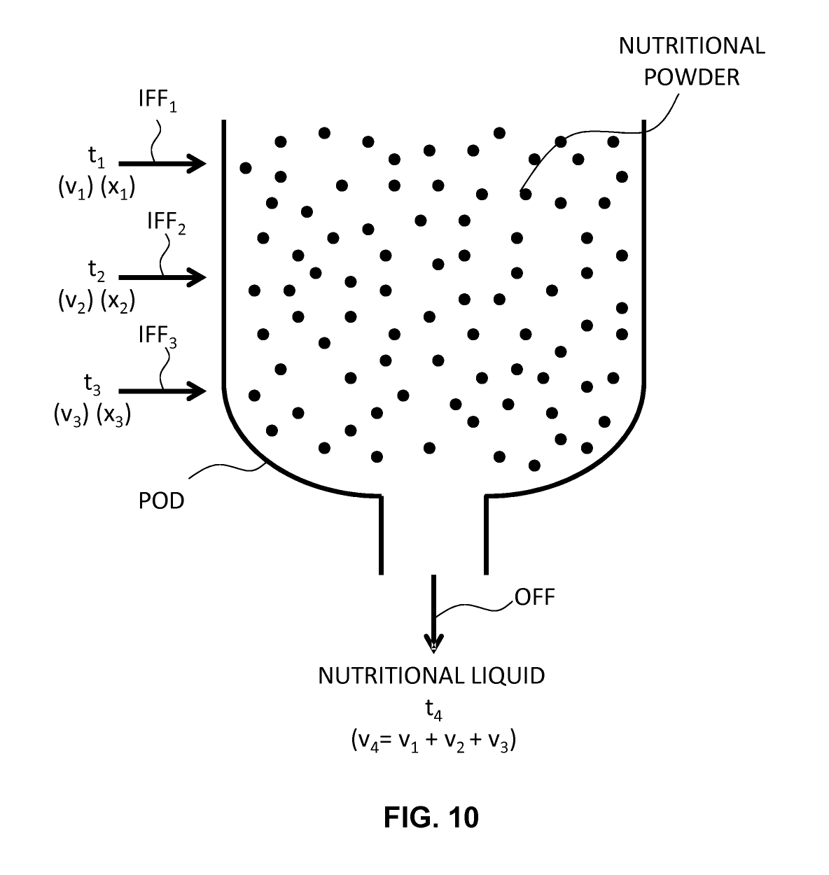

Example 10, as shown in FIG. 10, is similar to example 8 but with all three separate input fluid flows IFF₁, IFF₂, and IFF₃ being introduced into the pod at different input locations on the same side of the pod.

### Example 11

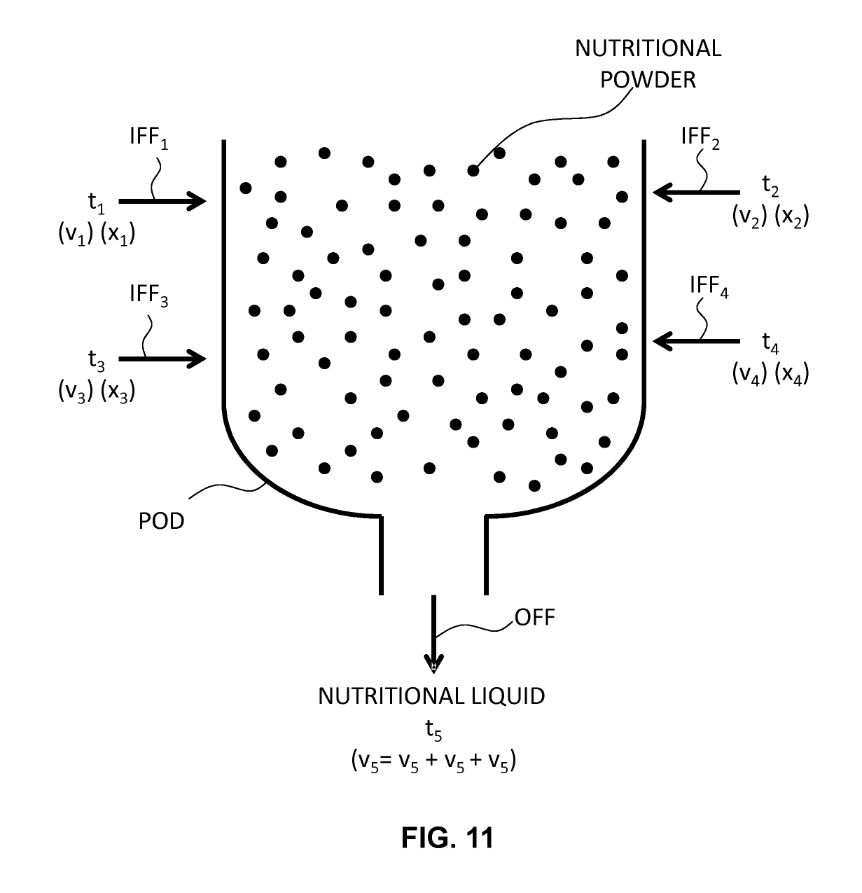

In example 11, as shown in FIG. 11, four input fluid flows (IFF₁, IFF₂, IFF₃, and IFF₃) are introduced into a pod containing a nutritional powder. The IFF₁ represents a volume v₁ of a first fluid (e.g., water) entering the pod. The IFF₂ represents a volume v₂ of a second fluid (e.g., water) entering the pod. The IFF₃ represents a volume v₃ of a third fluid (e.g., water) entering the pod. The IFF₄ represents a volume v₄ of a fourth fluid (e.g., water) entering the pod. In this example, each of the volumes (v₁, v₂, v₃, and v₄) are different. Ideally, the same volume v₅ (where v₅=v₁+v₂+v₃+v₄) of fluid would also exit the pod, as an output fluid flow (OFF). The OFF includes the reconstituted nutritional powder.

In this example, the IFF₁, the IFF₂, the IFF₃, and the IFF₄ are separate input fluid flows being introduced into the pod at different input locations. In this example, two of the input fluid flows (i.e., the IFF₁ and the IFF₃) have different input locations on one side of the pod and two of the input fluid flows (i.e., the IFF₂ and the IFF₄) have different input locations on the opposite side of the pod. In this example, the input fluid flows (IFF₁, IFF₂, IFF₃, and IFF₄) begin being introduced into the pod at different times (i.e., have different initiation times x₁, x₂, x₃, and x₄).

In this example, the IFF₁ has a temperature t₁ as it enters the pod, the IFF₂ has a temperature t₂ as it enters the pod, the IFF₃ has a temperature t₃ as it enters the pod, and the IFF₄ has a temperature t₄ as it enters the pod. Because the volumes v₁, v₂, v₃, and v₄ of the input fluid flows IFF₁, IFF₂, IFF₃, and IFF₄ are introduced into the pod at different temperatures (i.e., t₁, t₂, t₃, and t₄), the OFF will typically have a temperature t₅ that is between the highest and lowest of these temperatures. In this manner, the benefits of using particular volumes of particular fluids having particular temperatures can be obtained, while still obtaining a product having a desired output temperature. For example, the values of v₁, v₂, v₃, v₄, t₁, t₂, t₃, t₄, x₁, x₂, x₃, and x₄ can be adjusted to obtain desired processing characteristics and/or the desired output temperature.

### Example 12

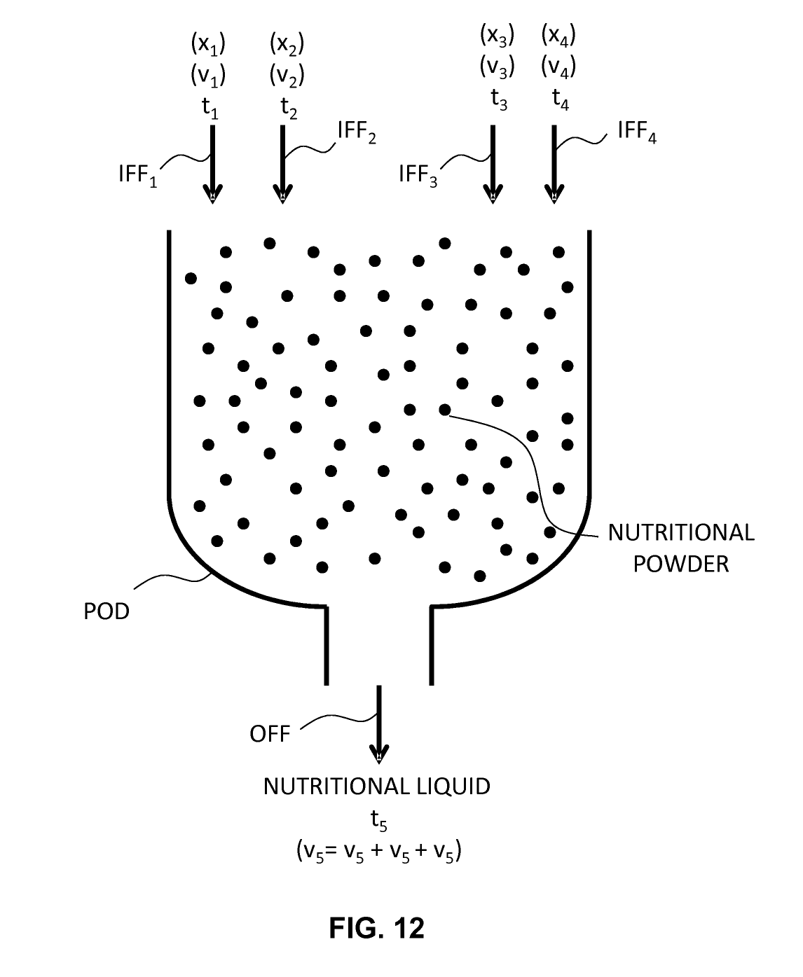

Example 12, as shown in FIG. 12, is similar to example 11 but with all four separate input fluid flows IFF₁, IFF₂, IFF₃, and IFF₄ being introduced into the pod at different input locations on the same side of the pod, with all of the input locations (i.e., for IFF₁, IFF₂, IFF₃, and IFF₄) being on the opposite side of the pod as the output location for the output fluid flow OFF.

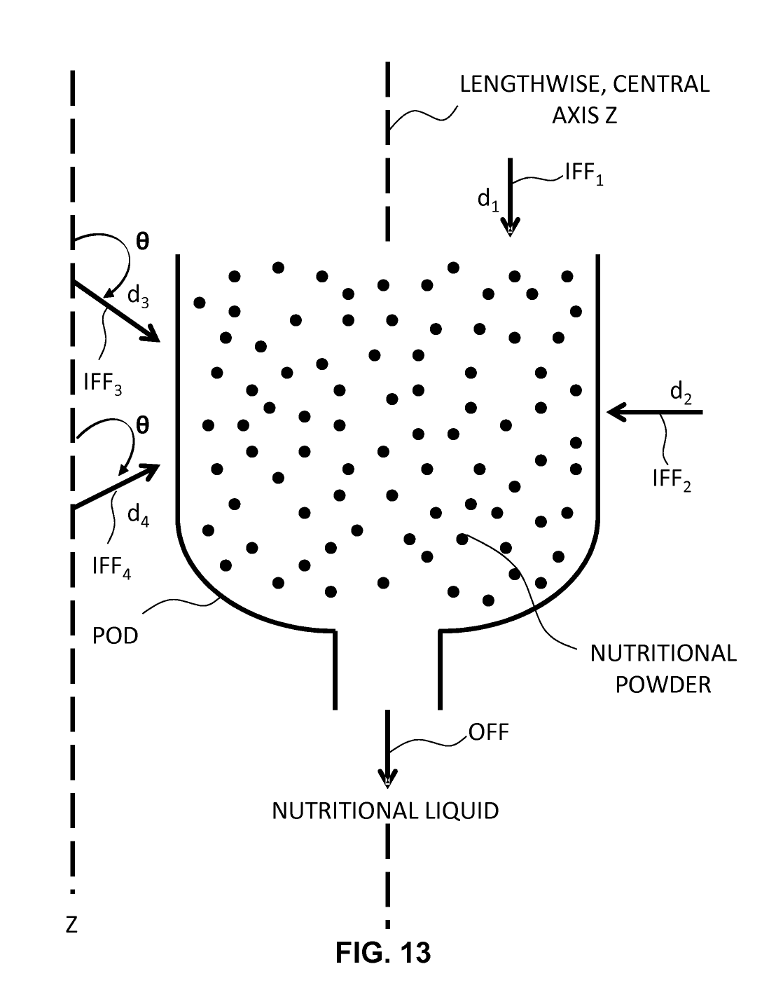

The above examples can be modified to include other fluid flow parameters, as well, to further enhance the benefits of using particular volumes of particular fluids having particular temperatures. For example, all of the input fluid flows (IFFs) described above will have an associated input direction. The input directions can be defined in any manner sufficient to ensure consistent orientation of the fluid flows when processing pods. For example, as shown in FIG. 13, the input direction d of an input fluid flow IFF is given relative to a lengthwise, central axis z of the pod. In particular, a first exemplary input fluid flow IFF₁ has an input direction d₁ that is parallel to the axis z; a second exemplary input fluid flow IFF₂ has an input direction d₂ that is perpendicular to the axis z; a third exemplary input fluid flow IFF₃ has an input direction d₃ that forms an angle with the axis z of greater than 90 degrees; and a fourth exemplary input fluid flow IFF₄ has an input direction d₄ that forms an angle with the axis z of less than 90 degrees.

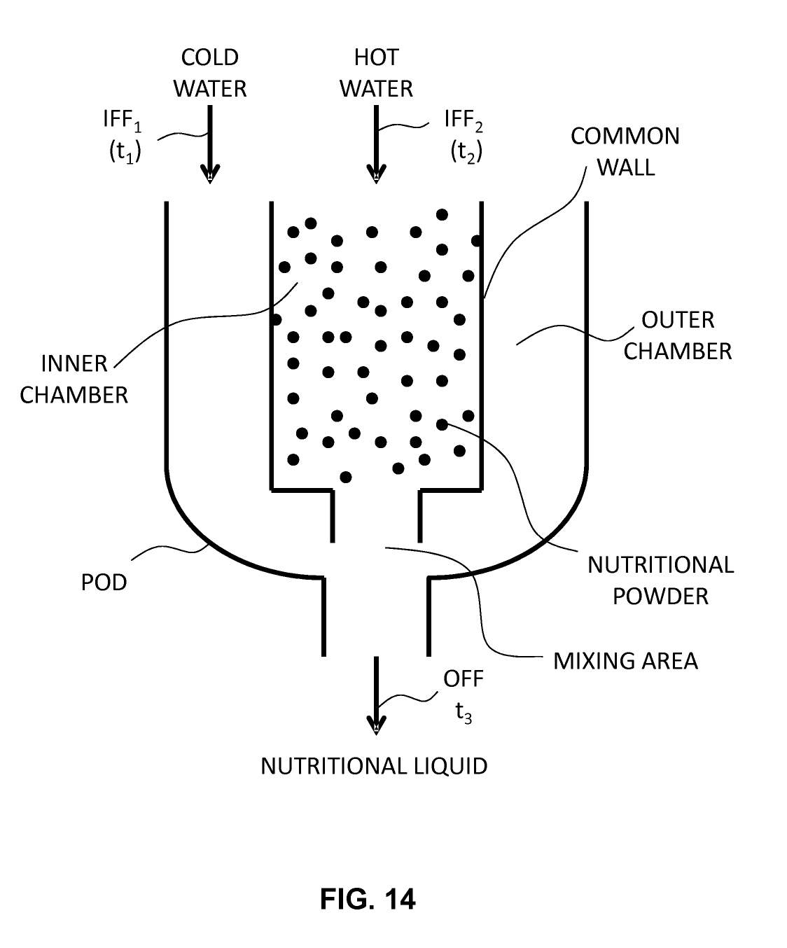

The general inventive concepts encompass pods of varying sizes and shapes. In one exemplary embodiment, as shown in FIG. 14, the pod defines a substantially cylindrical cavity in which an outer chamber and an inner chamber are defined. The outer chamber and the inner chamber are separated by a common wall with the outer chamber surrounding the inner chamber. The inner chamber is filled with a quantity of a formulation (e.g., a nutritional powder), while the outer chamber does not include any of the formulation. In an alternative embodiment, the outer chamber is filled with the formulation, while the inner chamber does not include any of the formulation. A common area below the outer chamber and the inner chamber serves as a mixing area. A first fluid flow of cold water (having a temperature t₁) can be introduced into the outer chamber, while a second fluid flow of hot water (having a temperature t₂) can be introduced into the inner chamber. For example, the first fluid flow and the second fluid flow can be introduced simultaneously. In this manner, the hot water contacts the nutritional powder to reconstitute it into a nutritional liquid that can then exit the pod as an output fluid flow OFF. At about the same time, the cold water fills the outer chamber and flows through the pod where it acts to cool the contents in the inner chamber by conduction through the common wall. Furthermore, as the hot water and the cold water leave their respective chambers, they flow together in the mixing area below the chambers so that the cold water can further regulate the temperature of the hot nutritional liquid. In this manner, the nutritional liquid exiting the pod can have a desired temperature t₃ (e.g., suitable for oral consumption or administration) between t₁ and t₂.

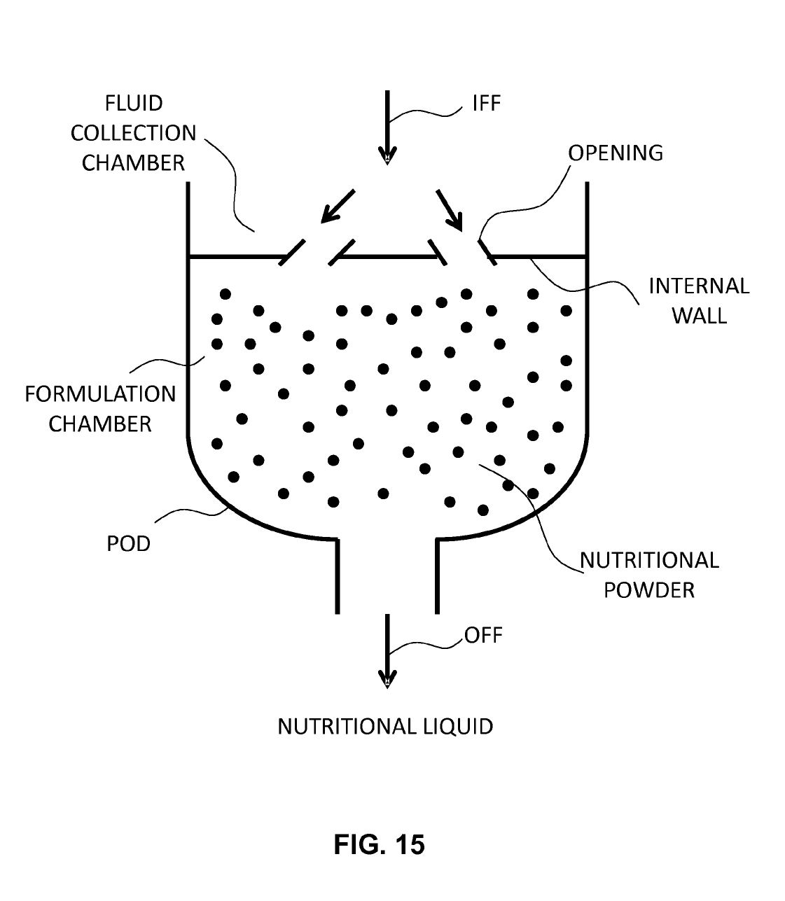

In another exemplary embodiment, as shown in FIG. 15, the pod defines a substantially cylindrical cavity in which an upper chamber (i.e., fluid collection chamber) and a lower chamber (i.e., formulation chamber) are defined. The fluid collection chamber and the formulation chamber are separated by a common internal wall with the fluid collection chamber situated above the formulation chamber. The formulation chamber is filled with a quantity of a formulation (e.g., a nutritional powder), while the fluid collection chamber does not include any of the formulation. A fluid flow (e.g., water, air) being introduced into the pod must first enter the fluid collection chamber before it can enter the formulation chamber. The internal wall has one or more openings that allow the fluid in the fluid collection chamber to pass into the formulation chamber. In some embodiments, the fluid can only pass through the openings after a predetermined condition is met. In some embodiments, the predetermined condition is a quantity of the fluid being in the fluid collection chamber. In some embodiments, the predetermined condition is a period of time after the initiation time of the fluid flow. In some embodiments, the openings in the internal wall prevent any of the formulation from passing from the formulation chamber into the fluid collection chamber. For example, a filter, membrane, one-way valve, or other structure can be present at the openings to allow the fluid to pass through the openings while preventing the formulation from passing through the openings. In this manner, an input fluid flow (IFF) can be introduced into the pod with the IFF contacting or otherwise encountering structure (e.g., the fluid collection chamber, the internal wall) in the pod prior to reaching the formulation. Once the IFF reaches the formulation, it reconstitutes (or aids in reconstitution of) the formulation into a nutritional liquid that can then exit the pod as an output fluid flow (OFF).

All ranges and parameters, including but not limited to percentages, parts, and ratios, disclosed herein are understood to encompass any and all sub-ranges assumed and subsumed therein and every number between the endpoints. For example, a stated range of “1 to 10” should be considered to include any and all subranges between (and inclusive of) the minimum value of 1 and the maximum value of 10; that is, all subranges beginning with a minimum value of 1 or more (e.g., 1 to 6.1), and ending with a maximum value of 10 or less (e.g., 2.3 to 9.4, 3 to 8, 4 to 7), and finally to each number 1, 2, 3, 4, 5, 6, 7, 8, 9, and 10 contained within the range.

All references to singular characteristics or limitations of the present disclosure shall include the corresponding plural characteristic or limitation, and vice versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

In some embodiments, it may be possible to utilize the various inventive concepts in combination with one another (e.g., one or more of the first, second, third, etc., embodiments may be utilized in combination with each other). Additionally, any particular element recited as relating to a particularly disclosed embodiment should be interpreted as available for use with all disclosed embodiments, unless incorporation of the particular element would be contradictory to the express terms of the embodiment. Thus, in general, all individual embodiments and features thereof, as disclosed or suggested herein, may be combined in any manner consistent with the general inventive concepts. Accordingly, the systems, methods, pods, and formulations may comprise, consist of, or consist essentially of the essential elements disclosed or suggested, as well as any additional or optional element disclosed or suggested herein or otherwise useful in such applications.

Additional advantages and modifications will be readily apparent to those skilled in the art. Therefore, the disclosure, in its broader aspects, is not limited to the specific details presented therein, the representative embodiments, or the illustrative examples shown and described. Accordingly, departures may be made from such details without departing from the spirit or scope of the general inventive concepts.

1. A system for reconstituting a nutritional powder into a nutritional liquid, the system comprising a fluid delivery device and a pod,
wherein the pod defines a predetermined volume hermetically enclosing a predetermined quantity of the nutritional powder,
wherein the fluid delivery device introduces a volume of a first fluid into the pod at a first temperature,
wherein the fluid delivery device introduces a volume of a second fluid into the pod at a second temperature,
wherein at least one of the volume of the first fluid and the volume of the second fluid substantially reconstitutes the nutritional powder to form the nutritional liquid, and
wherein the nutritional liquid exits the pod at a third temperature.

2. The system of claim 1, wherein the first fluid is liquid water.

3. The system of claim 1, wherein the second fluid is liquid water.

4. The system of claim 1, wherein the first fluid is steam.

5. The system of claim 1, wherein the second fluid is steam.

6. The system of claim 1, wherein the first fluid is air.

7. The system of claim 1, wherein the second fluid is air.

8. The system of claim 1, wherein the first temperature is greater than the second temperature.

9. The system of claim 1, wherein the first temperature is less than the second temperature.

10. The system of claim 1, wherein the first temperature is greater than the third temperature, and
wherein the second temperature is less than the third temperature.

11. The system of claim 1, wherein |(the third temperature−the first temperature)|>|(the third temperature−the second temperature).

12. A method of reconstituting a nutritional powder into a nutritional liquid, said nutritional powder being hermetically sealed in a pod, the method comprising:
disrupting the pod to form at least one opening therein;
introducing a first volume of water into the pod through the at least one opening at a first temperature and a second volume of water into the pod through the at least one opening at a second temperature, wherein at least one of the first volume of water and the second volume of water substantially reconstitutes the nutritional powder to form the nutritional liquid, and
discharging the nutritional liquid from the pod through the at least one opening at a third temperature.

13. The method of claim 12, wherein a rate of reconstitution of the nutritional powder in the water at the first temperature is greater than the rate of reconstitution of the nutritional powder in the water at the second temperature.

14. The method of claim 12, wherein the first temperature is greater than the second temperature.

15. The method of claim 12, wherein the first temperature is less than the second temperature.

16. The method of claim 12, wherein the first temperature is greater than the third temperature, and
wherein the second temperature is less than the third temperature.

17. The method of claim 12, wherein |(the third temperature−the first temperature)|>|(the third temperature−the second temperature)|.

18. The method of claim 12, further comprising introducing a volume of air into the pod through the at least one opening.

19. A pod for housing a predetermined quantity of a nutritional powder, the pod comprising:
a body having an upper surface, a lower surface, and one or more walls connecting the upper surface and the lower surface, said body defining an interior volume,
wherein the pod hermetically encloses the nutritional powder in the interior volume,
wherein said body includes one or more internal walls defining at least a first chamber and a second chamber in the interior volume,
wherein the nutritional powder is located in the first chamber,
wherein the second chamber is substantially free of nutritional powder,
wherein the body includes a mixing chamber formed in the interior volume,
wherein the first chamber and the second chamber are adjacent to one another,
wherein the mixing chamber is situated below the first chamber and the second chamber, and
wherein the mixing chamber is operable to receive a first fluid introduced into the pod at a first temperature after it passes through the first chamber and a second fluid introduced into the pod at a second temperature after it passes through the second chamber, thereby promoting mixing of the first fluid, the second fluid, and the nutritional powder.

20. The pod of claim 19, wherein the one or more internal walls allow heat transfer between the first fluid situated on one side of the internal walls and the second fluid situated on the opposite side of the internal walls.
